(19) United States
(12) Patent Application Publication
(10) Pub. No.: US 2026/0340512 A1
(43) Pub. Date: Oct. 29, 2026

(54) UNCERTAINTY PREDICTION MODELS

(71) Applicant: Indigo Ag, Inc., Charlestown, MA (US)

(72) Inventors: Eli Kellen MELAAS, Needham, MA (US); Bobby Harold BRASWELL, Portsmouth, NH (US); Jordan GRAESSER, Sydney (AU)

(21) Appl. No.: 19/110,739

(22) PCT Filed: Sep. 15, 2023
(86) PCT No.: PCT/US2023/032930

§ 371 Date: Mar. 11, 2025

Related U.S. Application Data
(60) Provisional application No. 63/375,838, filed on Sep. 15, 2022.
(60) Provisional application No. 63/386,378, filed on Dec. 7, 2022.

(51) Int. Cl. G06N 20/20

(52) U.S. Cl. CPC G06N 20/20

(57) ABSTRACT

A method of determining an uncertainty of a machine learning model. The method includes initializing a plurality of models, each with a unique set of model parameters, reading a training dataset, selecting a unique subset of the training dataset for each of the plurality of models, training each of the plurality of models according to its unique set of model parameters and unique subset of the training data, reading a validation dataset, applying each of the plurality of models to the validation dataset to obtain a plurality of output distributions, determining an uncertainty from the plurality of output distributions.

### RELATED APPLICATION(S)

This application claims the benefit of priority to U.S. Provisional Application No. 63/375,838 filed Sep. 15, 2022, and U.S. Provisional Application No. 63/386,378, filed Dec. 7, 2022, both of which are incorporated herein by reference in their entirety.

### BACKGROUND

Embodiments of the present disclosure relate to determining an uncertainty of a machine learning model and determining an uncertainty of a prediction, and more specifically, to training ensemble machine learning uncertainty prediction models and performing Bayesian inferences to determine overall uncertainty predictions by geographical position.

### BRIEF SUMMARY

According to embodiments of the present disclosure, methods of and computer program products for determining an uncertainty of a machine learning model include initializing a plurality of models, each with a unique set of model parameters, reading a training dataset, selecting a unique subset of the training dataset for each of the plurality of models, training each of the plurality of models according to its unique set of model parameters and unique subset of the training data, reading a validation dataset, applying each of the plurality of models to the validation dataset to obtain a plurality of output distributions, determining an uncertainty from the plurality of output distributions.

According to embodiments of the present disclosure, methods of and computer program products for determining an uncertainty of a prediction includes for a first geographic region, determining a historical value of a first parameter. The method includes for a second geographic region, determining a predicted value of the first parameter, the second geographical region being a subregion of the first geographical region. The method includes determining a posterior probability of the predicted value based on the historical value. The method includes determining an uncertainty of the predicted value based on the posterior probability.

According to embodiments of the present disclosure, a system includes one or more datastore comprising a training dataset and a validation dataset. The system includes a computing node comprising a computer readable storage medium having program instructions embodied therewith, the program instructions executable by a processor of the computing node to cause the processor to perform a method according to an embodiments of the disclosed subject matter.

According to embodiments of the present disclosure, a computer program product for predicting the uncertainty of a model output includes a computer readable storage medium having program instructions embodied therewith, the program instructions executable by a processor to cause the processor to perform a method according to embodiments of the disclosed subject matter.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE SEVERAL VIEWS OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 depicts a flow diagram of a method for determining an uncertainty of a machine learning model, in accordance with embodiments of the disclosed subject matter.

FIG. 2 depicts a Bayesian Graphical Model (BGM) consisting of five nodes, in accordance with embodiments of the disclosed subject matter.

FIG. 3 depicts a logistic regression in block diagram form in accordance with embodiments of the disclosed subject matter.

FIG. 4 depicts a flow diagram of an approach to determine an uncertainty utilizing time series and tree-bases classifiers with engineered features, in accordance with embodiments of the disclosed subject matter.

FIG. 5 depicts a flow diagram of a method for determining an uncertainty of a prediction, in accordance with embodiments of the disclosed subject matter.

FIG. 6 depicts a box diagram of a system configured to execute one or more methods according to embodiments of the disclosed subject matter.

FIG. 7A-D depict a series of plots of the probability of maize being planted vs. posterior, showing the reduction of uncertainty and the reduction in the prior weight with an increasing sample size of estimate planted area of maize across the country, in accordance with embodiments of the disclosed subject matter.

FIG. 8 depicts a plot of probability of fallow planted vs. posterior, showing the effect of a small sample size relative to FIGS. 6A-D, in accordance with embodiments of the disclosed subject matter.

FIG. 9A-B are plots of density vs. Normalized Difference Tillage Index (NDTI) and Normalized Different Vegetation Index (NDVI), respectively, in accordance with embodiments of the disclosed subject matter.

FIG. 10A-B are plots depicting density vs. NDTI minimums for the year 2015 and 2020, respectively, in accordance with embodiments of the disclosed subject matter.

FIG. 11A-B are plots depicting density vs. NDVI for the year 2016 and 2020, respectively, in accordance with embodiments of the disclosed subject matter.

FIG. 12 is a plot of posterior distributions of the variables alpha, beta, from a logistic function, in accordance with embodiments of the disclosed subject matter.

FIG. 13 is a plot of posterior probability estimates vs. NDTI minimum, in accordance with the embodiments of the disclosed subject matter.

FIG. 14 is a plot of posterior probability estimates vs. NDVI, in accordance with the embodiments of the disclosed subject matter.

FIG. 15 is a plot of harvest date uncertainty, in accordance with the embodiments of the disclosed subject matter.

FIG. 16 is a plot of planting date prediction uncertainty for soy, in accordance with the disclosed subject matter.

FIG. 17 is a plot of planting date prediction uncertainty for corn, in accordance with the disclosed subject matter.

FIG. 18 is a plot of planting date bound width over time for soy, in accordance with the disclosed subject matter.

FIG. 19 is a plot of planting date bound width over time for corn, in accordance with the disclosed subject matter.

FIG. 20 is an exemplary overall workflow for predicting an uncertainty of a machine learning model, in accordance with the disclosed subject matter.

FIG. 21 is an exemplary workflow for a single algorithm, in accordance with the disclosed subject matter.

FIG. 22 is a series of graphs illustrating training data, in accordance with the disclosed subject matter.

FIG. 23 is a plot of posterior probability estimates vs. NDTI, in accordance with the disclosed subject matter.

FIG. 24A is an exemplary map of generated inference results, in accordance with the disclosed subject matter.

FIG. 24B-D is a series of exemplary nationwide validation statistics for a variety of crops, in accordance with the disclosed subject matter.

FIG. 25 is a schematic showing the probability of tillage detection and associated width of uncertainty bounds, in accordance with the disclosed subject matter.

FIG. 26A is a graph of class probability for tillage, in accordance with the disclosed subject matter.

FIG. 26B is a graph of likelihood for tillage, in accordance with the disclosed subject matter.

FIG. 27A is a graph of class probability for a cover crop, in accordance with the disclosed subject matter.

FIG. 27B is a graph of likelihood for a cover crop, in accordance with the disclosed subject matter.

FIG. 28A is a graph of class probability for irrigation, in accordance with the disclosed subject matter.

FIG. 28B is a graph of likelihood for irrigation, in accordance with the disclosed subject matter.

FIG. 29 is a graph showing the total agricultural field area will be above a threshold using likelihood, in accordance with the disclosed subject matter.

FIG. 30 is a graph showing the total agricultural field area will be above a threshold using F1 score, in accordance with the disclosed subject matter.

FIG. 31A is a graph illustrating the adjusted likelihood for tillage, in accordance with the disclosed subject matter.

FIG. 31B is a graph illustrating the adjusted likelihood for a cover crop, in accordance with the disclosed subject matter.

FIG. 31C is a graph illustrating the adjusted likelihood for irrigation, in accordance with the disclosed subject matter.

FIG. 32 is a graph illustrating the coverage based on field level likelihood, with respect to tillage, a cover crop, and irrigation, in accordance with the disclosed subject matter.

FIG. 33A is a plot of an adjusted regressor model for yield, in accordance with the disclosed subject matter.

FIG. 33B is an adjusted regressor model for yield, in accordance with the disclosed subject matter.

FIG. 34A is a scatter plot showing percent error vs. confidence interval for soy, in accordance with the disclosed subject matter.

FIG. 34B is a scatter plot showing percent error vs. prediction interval for soy, in accordance with the disclosed subject matter

FIG. 35A is a graph of an anomaly index from the isolation forests for tillage, in accordance with the disclosed subject matter.

FIG. 35B is a graph of an anomaly index from the isolation forests for cover crop, in accordance with the disclosed subject matter.

FIG. 36 is a bar graph illustrating RS detection vs. growing attestation, in accordance with the disclosed subject matter.

FIG. 37 is a bar graph illustrating an irrigation anomaly index, in accordance with the disclosed subject matter.

FIG. 38 is a bar graph illustrating a crop yield anomaly index, in accordance with the disclosed subject matter.

FIG. 39 is a bar graph illustrating a tillage anomaly index, in accordance with the disclosed subject matter.

FIG. 40 is a bar graph illustrating a cover crop anomaly index, in accordance with the disclosed subject matter.

FIG. 41 is a graph illustrating the fraction anomaly index greater than 0.5 across a series of algorithms and U.S. counties, in accordance with the disclosed subject matter.

FIGS. 42-69 show the distributions of likelihood across counties, one county from each crop management zone (“CMZ”), for each of the classifier algorithms, in accordance with the disclosed subject matter.

FIGS. 70-74 show the likelihood of each classifier algorithm vs F1 score, in accordance with the disclosed subject matter.

FIG. 75 depicts a computing node according to embodiments of the present disclosure.

### DETAILED DESCRIPTION

Reference will now be made in detail to exemplary embodiments of the disclosed subject matter, an example of which is illustrated in the accompanying drawings. The method and corresponding steps of the disclosed subject matter will be described in conjunction with the detailed description of the system.

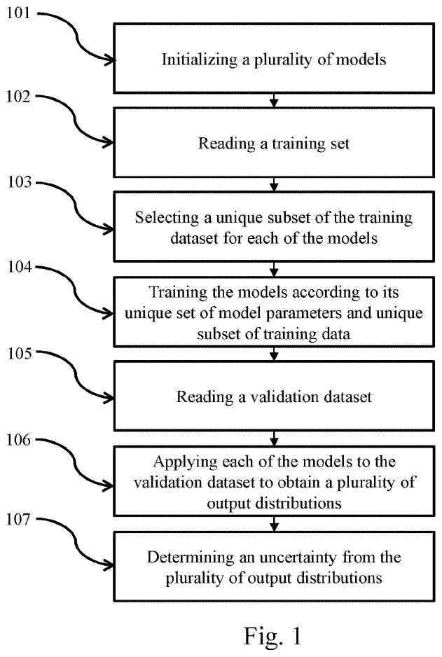

The methods and systems presented herein may be used for determining an uncertainty of a machine learning model and determining an uncertainty of a prediction. The disclosed subject matter is particularly suited for training ensemble machine learning uncertainty prediction models and performing Bayesian inferences to determine overall uncertainty predictions by geographical position. For purpose of explanation and illustration, and not limitation, an exemplary embodiment of the system in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures.

For a field, and for a specific time period, the algorithms described herein provide classifiers or regressors. Classifiers, which output a class label (e.g., a yes or no output), are used in various embodiments for cover crop detection, tillage detection, and/or irrigation detection. In various embodiments, likelihood information is determined for a classifier, based on a logistic regression of the probability outputs of the classifier models, i.e., the likelihood that the prediction is correct. Regressors, which return a quantitative value, are used in various embodiments for crop yield (bu/ac), planting date (day) and/or harvest date (day). In various embodiments, a confidence interval is determined for a regressor, providing a variance-of-the-mean type statistic.

In addition to validation metrics (e.g., F1 score and MAE), uncertainty information includes probability (classifiers), prediction intervals (regressors) and other metrics not related to the reliability of an individual prediction. As used herein, probability refers to an output of a machine learning (ML) algorithm and is a measure of the probability that an outcome occurred.

Remote sensing algorithms, such as those disclosed herein, rely on relationships between observed changes in brightness in different spectral bands, for pieces of land that are relatively large (~30 m) compared to fields, irregularly shaped, and imperfectly geolocated within the field, relative to a grower's practices which directly or indirectly affect how the land interacts with light in complicated ways, and is sometimes completely unobservable due to clouds.

Uncertainty is generally related to: (1) the known accuracy of a model in general, with validation statistics like F1-score, accuracy, MAE, MSE, etc., and based on out-of-sample cross-validation using ground truth; and (2) the estimated quality of an individual prediction (“event level uncertainty”), where quality refers to specific metrics. The specific metrics include the likelihood that the predicted class is the correct class for classifiers, and the likely lower and upper quantiles of the distribution of the predicted value. While both (1) and (2) are useful, the latter should not necessarily replace the former.

In general, the ability for a system to provide meaningful uncertainty metrics for each data product estimate is beneficial to stakeholders, and can be tracked and used to decide how or when to use said estimate. Additionally, uncertainty metric can help when it is necessary to know whether to use an observation or not-addressing question like: is the observation from a model that works? Is the observation likely to be correct? Does the observation have large error bars? The large scale analysis on a county or country size sample of land requires not only modeling but uncertainties associated with the outputs of said models.

It is not recommended to use uncertainty information to decide whether a grower value is consistent or not. For classifiers, the prediction will either agree (e.g., till, no-till) or not, and the user will have already used the uncertainty information to decide whether or not to use the prediction. For regressors, it is reasonable to want a rule to decide whether the predicted value is accurate enough, but there is not an objective way to select an agreement criterion. It's tempting to want to use an uncertainty range (e.g., if the grower value is in the range, then they agree), however this becomes more permissive the worse the model result is, and probably conflicts with the spirit of QAQC.

While it is recommended that growers select their own thresholds based on details of their own use case and the known tradeoffs, embodiments of the present disclosure provide information to inform growers about what the tradeoffs are. For example, a grower may determine what happens when predictions with uncertainty below a certain threshold are dropped.

In the following discussion, probability and likelihood are used differently. The first is an output of a model that indicates the probability that something happened; and the second is the likelihood that the model is correct for a given sample. For classifiers, the probability of each class label is output. For example, a tilled probability may be 0.67, and the corresponding not tilled probability is 0.33. The probabilities sum to one, and in this case the prediction is returned as “tilled.” A simple way to get the likelihood of correctness it to use the probability of the prediction. For example, if the prediction is “tilled,” the likelihood is then 0.67.

With reference now to FIG. 1, a method 100 of determining an uncertainty of a machine learning model is depicted in flow diagram form. The method 100 includes, at step 101, initializing a plurality of models, each with a unique set of model parameters. Each of the plurality of models may include a random forest. Each of the plurality of models may include linear regression, logistic regression, decision tree, SVM, Naïve Bayes classifier, KNN, dimensionality reduction algorithm, gradient boosting algorithm, a combination thereof, or another type of model. LightGBM and CatBoost may be used in multiple algorithms for their computational speed and their results as compared to similar algorithms (e.g., Gradient Boosting) in machine learning competitions.

The unique set of model parameters may be generated by one or more machine learning models, may be input by a user, or automatedly selected from a pool of model parameters. The unique set of model parameters for each of the plurality of models may include at least one randomized model parameter. A preferred set of model parameters may be selected for modeling. The at least one randomized model parameter may be selected utilizing simple, block, stratified, dynamic and/or unequal randomization. Each algorithm may be optimized by running variations of parameters on training data, predicting on withheld data, and using the set of parameters that gave the base estimates on the withheld data. It will be appreciated that in various embodiments the model parameters are referred to as hyperparameters, to distinguish them from, e.g., ANN weights that are determined during training.

With reference to FIG. 1, a method 100 of determining an uncertainty of a machine learning model includes, at step 102, reading a training dataset. The machine learning model may be initially fit on the training dataset. The machine learning model may perform supervised or unsupervised learning. According to embodiments of the disclosed subject matter, the training dataset includes inputs and desired outputs.

With continued reference to FIG. 1, a method 100 for determining an uncertainty of a machine learning model includes, at step 103, selecting a unique subset of the training dataset for each of the plurality of models. Selecting a unique subset of the training dataset may include selecting randomly. Methods of random selection that may be utilized, according to non-exhaustive embodiments of the present subject matter includes block, simple, stratified, dynamic and/or unequal randomization. Stratified sampling may be applied so that the models 1) do not split geo ids/year combinations and 2) ensure a balanced split of target labels (in the case of classification problems). For the second point, this is particularly important when dealing with class categories with limited counts/examples because it is desirable to include examples of each target in training and in validation datasets. While various embodiments employ a Random Forest, it will be appreciated that a variety of alternative models may be employed.

With continued reference to FIG. 1, a method 100 for determining an uncertainty of a machine learning model includes, at step 104, training each of the plurality of models according to its unique set of model parameters and unique subset of the training data. Training each of the plurality of models may include utilizing a supervised or unsupervised learning method. Supervised learning may include learning a function that maps the input to the output based on the training dataset and unique subset of the training data. A supervised learning algorithm may analyze the training data and produces an inferred function, which can be used for mapping new examples. Unsupervised learning may be a type of algorithm that learns patterns from untagged data. In this learning type the machine learning model is trained based on capturing patterns as probability densities.

With continued reference to FIG. 1, method 100 for determining an uncertainty of a machine learning model includes, at step 105, reading a validation dataset. The validation dataset may provide an unbiased evaluation of a model fit on the training dataset. Validation datasets can be used for regularization by early stopping, wherein early stopping the training occurs when an error on the validation dataset increases. This increase in error on the validation dataset may be a sign of over-fitting to the training dataset. The validation dataset's error may fluctuate during training, producing multiple local minima.

With continued reference to FIG. 1, a method 100 for determining uncertainty of a machine learning model includes, at step 106, applying each of the plurality of models to the validation dataset to obtain a plurality of output distributions. Applying each of the plurality of models to the validation dataset may include providing the validation dataset to the plurality of machine learning models and obtaining therefrom the predictions made by said models. The validation dataset may provide an unbiased evaluation of a model fit on the training dataset. Validation datasets can be used for regularization by early stopping, wherein early stopping the training occurs when an error on the validation dataset increases. This increase in error on the validation dataset may be a sign of over-fitting to the training dataset. The validation dataset's error may fluctuate during training, producing multiple local minima. The method may include assigning a weigh to each of the plurality of models as a function of the validation dataset, e.g., a more accurate model is weighted more heavily than a less accurate model, or vice versa, according to embodiments.

With continued reference to FIG. 1, method 100 for determining uncertainty in a machine learning model includes, at step 107, determining an uncertainty from the plurality of output distributions. The method may further include assigning a weight to each of the plurality of models to produce a weighted ensemble model. The weights may be assigned as a function of the uncertainty determined for each of the plurality of models. For example, and without limitation, a model with higher uncertainty may be weighted less heavily than a model with a lower uncertainty, or vice versa, according to embodiments of the present subject matter. The weighted ensemble models may be applied to an input to determine a classification and an uncertainty, in embodiments of the present subject matter. The uncertainty may be provided to a prediction by one or more machine learning models. Certainty/uncertainty can be quantified by 1) calculating the entropy (Shannon's entropy) and 2) quantifying the probability of an estimate falling within a credible interval.

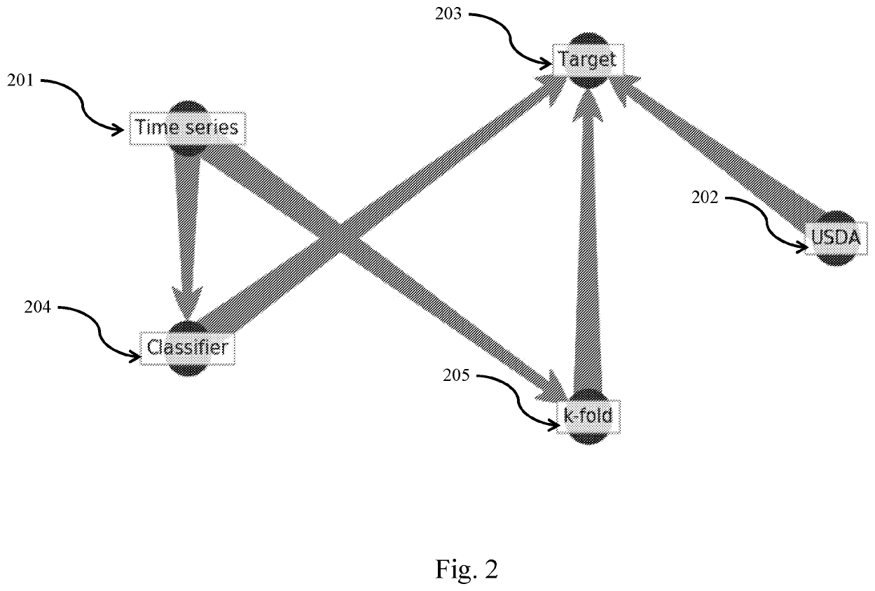

With reference now to FIG. 2, a Bayes Graphical Model (BGM) is depicted in schematic form. FIG. 2 consists of five nodes, two of which are priors (‘Time series’ 201, ‘USDA’ 202) and the other three are conditioned with evidence (the incoming directed edges represent evidence). The target node here is ‘Target’ 203, which represents the known labels (e.g., field data). This graph template enables generating conditional probability_distributions (CPDs) from known or observed contingency tables. For example, and without limitation, the ‘USDA’ node 202 here could represent any desired variable from USDA across the unit of a county, such as NASS planted area estimates for soybeans or the rate of cover crop adoption. In this case, a simple prior could be set for the entire county. More informed priors might come from observed data. For example, the ‘Time series’ node 201 might represent the fraction of missing data in a time series at the field level. Thus, the CPD for this node could be derived from observed data at every field in a training dataset. The ‘Classifier’ 204 and ‘k-fold’ 205 nodes would be conditioned on upstream nodes (in this case, ‘Time series’ 201). In other words, this model is saying that the likelihood of a classifier estimating 1|0 is conditional on the fraction of missing data in the time series. Similarly, for a single fold, the estimates from the fold are conditional on the time series. Finally, the target node represents the known label for a field, or set of fields. The CPD for ‘Target’ 203 is derived from the evidence of the three upstream nodes 204, 205, 202.

With the CPDs set for each node, an inference can be applied for any set of evidence. As an example, the P (Target|New evidence Target=1 (i.e., soy in this example), New evidence Time series=1 (or fraction missing bin 1)) is illustrated in the table below.

TABLE 1

| Target | phi (Target) |
|---|---|
| Target (0) | 0.2921 |
| Target (1) | 0.7079 |

Table 1 shows the posterior joint probability estimate for a single field and single fold. One approach to quantifying event-level uncertainty might then be to update the CPDs over a range of conditions to derive uncertainty bounds.

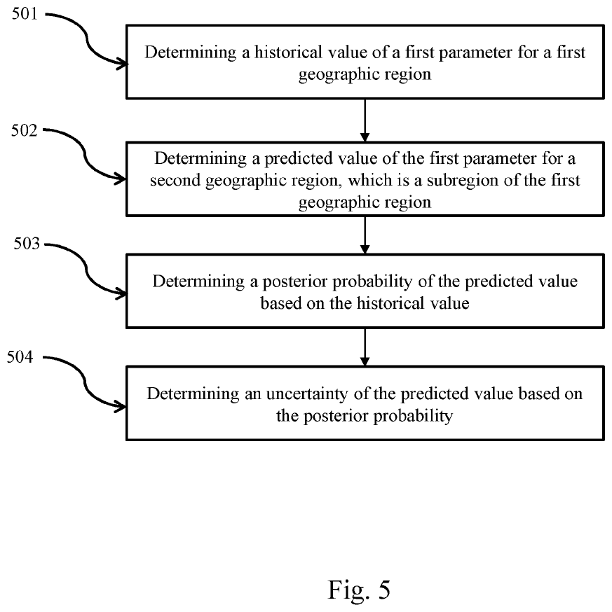

Referring now to FIG. 5, a method 500 for determining an uncertainty of a prediction is presented in flow diagram form. The method 500 for determining an uncertainty of a prediction includes, at step 501, for a first geographic region, determining a historical value of a first parameter. The first geographic region may be a field of corn, for example, or a plurality of fields, plots, farms, acres, hectares or another unit of measurement of land. A “field” is the area where agricultural production practices are being used (for example, to produce a transacted agricultural product) and/or ecosystem credits and/or sustainability claims. As used herein, a “field boundary” may refer to a geospatial boundary of an individual field. As used herein, an “enrolled field boundary” may refer to the geospatial boundary of an individual field enrolled in at least one ecosystem credit or sustainability claim program on a specific date.

An “indication of a geographic region” is a latitude and longitude, an address or parcel id, a geopolitical region (for example, a city, county, state), a crop management zone (CMZ), a region of similar environment (e.g., a similar soil type or similar weather), a supply shed, a boundary file, a shape drawn on a map presented within a GUI of a user device, image of a region, an image of a region displayed on a map presented within a GUI of a user device, a user id where the user id is associated with one or more production locations (for example, one or more fields). Crop management zone refers to an area in which similar crops are grown under similar climatic conditions, for example USDA-NRCS crop management zones.

For example, polygons representing fields may be detected from remote sensing data using computer vision methods (for example, edge detection, image segmentation, and combinations thereof) or machine learning algorithms (for example, maximum likelihood classification, random tree classification, support vector machine classification, ensemble learning algorithms, convolutional neural network, etc.).

The land may be utilized to grow vegetation, naturally or artificially, as in forests or farms, respectively. The historical value of a first parameter may be a parameter associated with vegetation within or around the first geographic region. The historical value of a first parameter may be pulled from an agricultural service, such an agricultural census. The historical value of a first parameter may be determined from agricultural census data. The historical value of a first parameter may include a date or time of tillage of a first geographic region or subset thereof. The historical value of a first parameter may include a time series of a parameter, such as tillage of a first geographic region over time. The first parameter may be one of cover crop presence, crop type, crop yield, harvest date, irrigation presence, planting date, tillage presence. In various embodiments, the first geographic region is a county. In various embodiments, the first geographic region is a state, country, continent, or hemisphere. In various embodiments, the first geographic region is at least one county. In various embodiments the first geographic region is a plurality of counties abutting one another.

With continued reference to FIG. 5, method 500 of determining an uncertainty of a prediction includes, at step 502, for a second geographic region, determining a predicted value of the first parameter, the second geographical region being a subregion of the first geographical region. The predicted value of the first parameter may be determined from one or more machine learning models, in embodiments. The predicted value of the first parameter may be associated with an agricultural service, such an agricultural census. The predicted value of a first parameter may be determined from agricultural census data or associated web tools therewith. The predicted value of a first parameter may include a date or time of tillage of a second geographic region or subset thereof. The predicted value of a first parameter may include a time associated with the first parameter, such as tillage of a second geographic region. In various embodiments the second geographic region is a field. In various embodiments the field may have clear boundaries. In various embodiments, the field may not have clear boundaries, only implied or partially implied boundaries. In various embodiments, the second geographic region is a county. In various embodiments, the second geographic region is a state, country, continent, or hemisphere. In various embodiments, the second geographic region is at least one county. In various embodiments the second geographic region is a plurality of counties abutting one another. In various embodiments, the second geographic region is a subregion of the first geographic region. In various embodiments a first geographic region may fully bound or partially bound the second geographic region.

With continued reference to FIG. 5, the method 500 for determining uncertainty of a prediction includes, at step 503, determining a posterior probability of the predicted value based on the historical value.

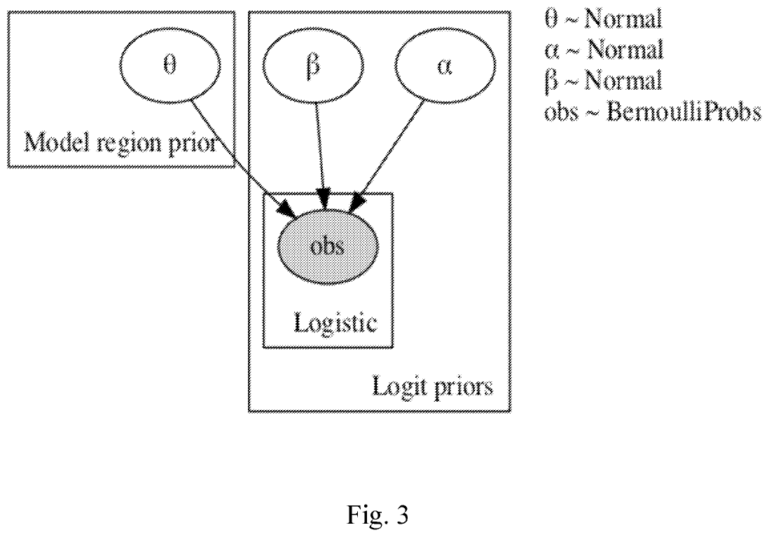

The algorithms may use tree-based (e.g., Random Forests, Decision trees, Gradient boosted trees) classifiers or regressors to estimate agricultural practices. These classifiers provide class conditional likelihoods of estimated target labels. However, they are typically not well-calibrated as proportional probabilities. With this in mind, the graphical structure of conditional dependencies can be adopted to a Bayesian framework by using model estimates as inputs into a logistic regression, as shown in FIG. 3. This allows incorporation of model-level (county, CMZ) priors as well as factors unaccounted for in the base classifier, such as time series density and field geometry uncertainty. With this approach, posteriors may be transformed using a logistic regression:

x=α+β×Classifier_likelihoods+θ*Region_prior+ . . . [potentially, other factors]

p=empit(x)=e\hat{ }x/(1+e\hat{ }x)

In some embodiments, algorithms that used a prior logistic regression adjustment use a single variable:

probability=expi(x)=e\hat{ }x/(1+e\hat{ }x)

where x=alpha+Beta*<ag census prior>

First, given a county and year, the rank percentile score of a time series-derived metric for each field can be computed. Then, assuming the adoption rate is constant across years (or, if possible, transect results may be substituted in), this rate can be used to estimate the magnitude of the metric (e.g., a “threshold”) at which the transition from till to no till, no cover to cover, or irrigation to rainfed may occur. In the case of cover crops, any fields classified as winter wheat, alfalfa, hay/pasture or double crop, which typically have relatively high late winter/early spring NDVI can be excluded. Based on this magnitude, fields are then re-classified as 0 or 1 depending on whether the metric value is above or below the determined threshold. Using the re-classified labels, a logistic regression while generating posterior distributions of each regression parameter can be estimated. Finally, based on the mean and variance of these posterior distributions, the probability of till vs. no till, cover vs. no cover or irrigation vs. rainfed for an individual field is quantified during a single year based on the magnitude of the time series-derived metric.

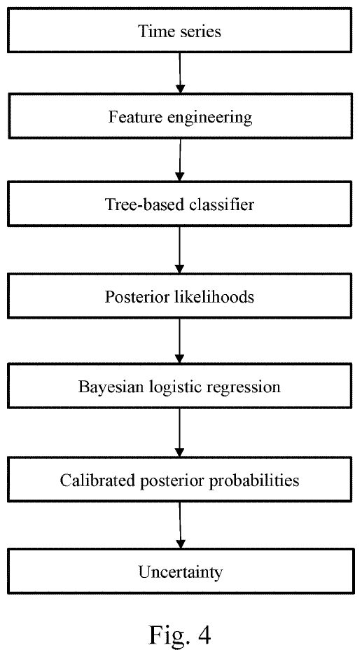

In embodiments of the currently disclosed subject matter, an approach may use tree-based classifiers with engineered features from remotely sensed time series (up to the fourth (grey) box in FIG. 4). Using a Bayesian logistic regression, event-level uncertainty can be fit and, therefore, estimated implicitly in the model using the outputs of current classifiers.

A time series 401 is taken as input. Based on feature engineering 402, a set of features is defined and extracted from time series 401. The features are provided to classifier 403, which outputs posterior likelihoods 404. Bayesian logistic regression 405 is applied to obtain calibrated posterior probabilities 406, yielding uncertainty 407.

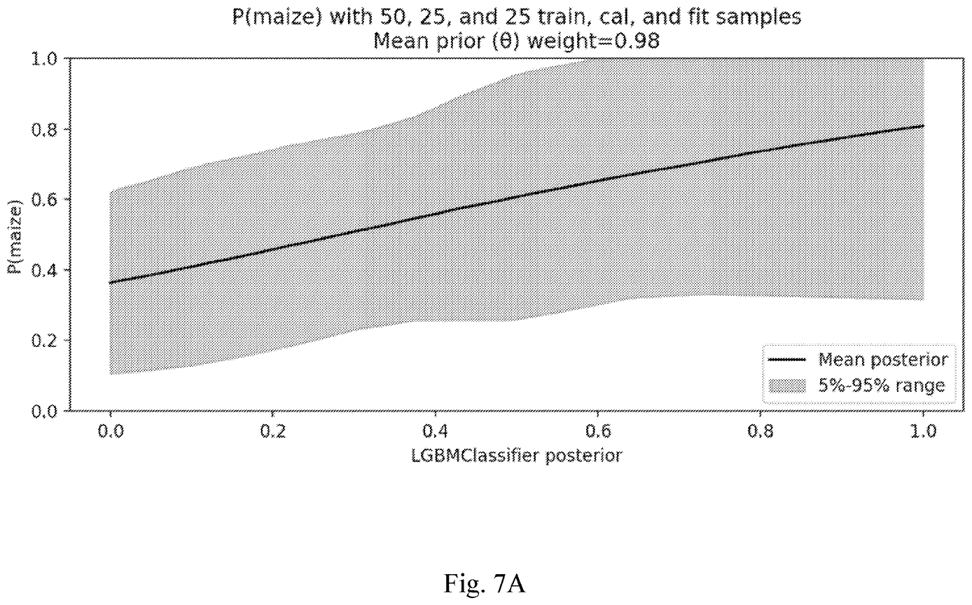

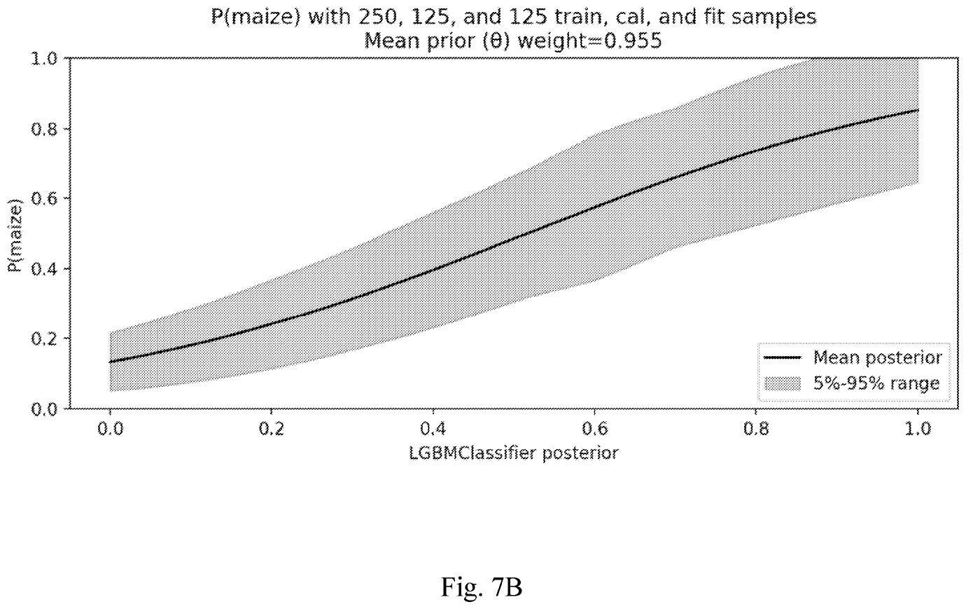

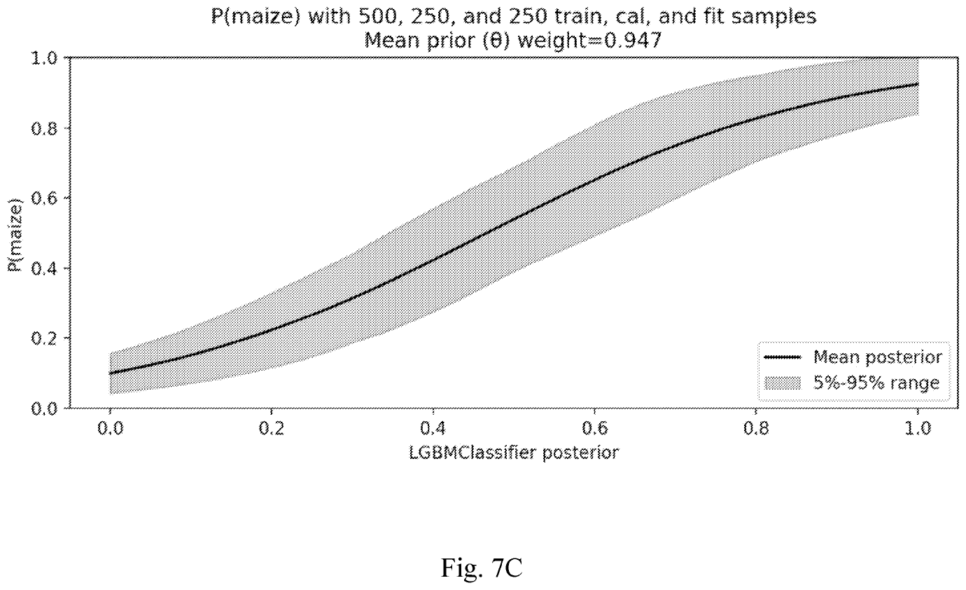

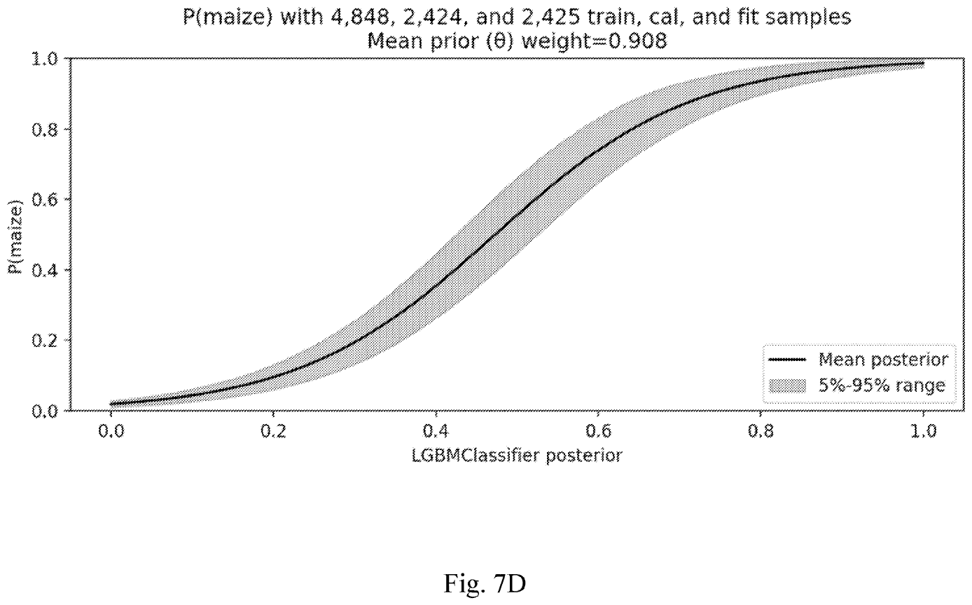

Referring to FIGS. 7A-D, plots are provided using crop type as an example, with the objective to estimate the likelihood (with uncertainty) that a field planted maize (0=not maize; 1=maize). FIGS. 7A-D illustrate the reduction in uncertainty and the reduction in the prior weight with an increasing sample size. In this example, the prior is set as a fraction of the estimated planted area of maize across the county. As more samples are used to fit the gradient boosted tree classifier and the logistic regression, the prior weight becomes less important and the uncertainty in the tails of the sigmoid function reduces. The results of these prior weights are shown in reference to the plots depicted by FIGS. 7A-D. In embodiments of the present disclosure, out of all samples from FIG. 7D, there were a total of 5,294 possible maize fields to sample from.

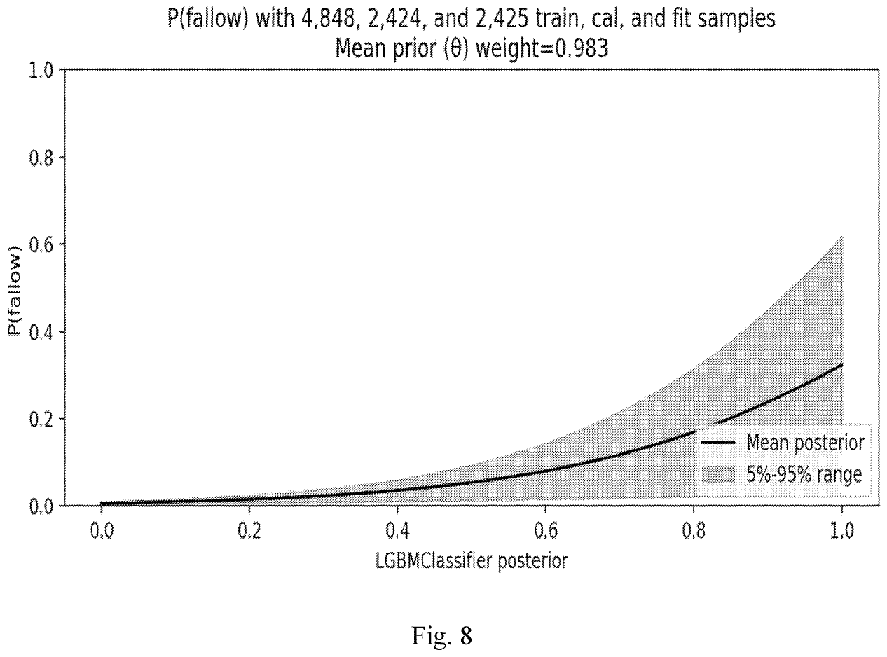

Alternatively, with reference to FIG. 8, in the same dataset used to generate FIGS. 7A-D, there are only 49 fallow fields. FIG. 8 shows the effect of a small sample size. Even when the tree classifier is very confident, the model outputs a much lower posterior with high uncertainty.

With continued reference to FIG. 5, a method 500 for determining uncertainty of a prediction includes, at step 504, determining an uncertainty of the predicted value based on the posterior probability. The uncertainty for a single field is determined by plugging in the mean value of the posterior distribution of each parameter from the logistic regression. An agricultural field unit (crop fields in one case) is the highest (smallest) level of detail that is used to develop and apply to the models. When the models are trained, multiple fields to counties or a collection of counties are aggregated. Thus, information from a geographic area larger than a field is used to train the algorithms/models. When the models are applied to make estimates about an agronomic practice, each field available to use is included in one or more predictions. In other words, a model trained to estimate the presence/use of irrigation to every field across a county is applied. When the estimates are reported and delivered they include the geometry (e.g., where the field is located and how it is shaped) along with the estimate for that particular field.

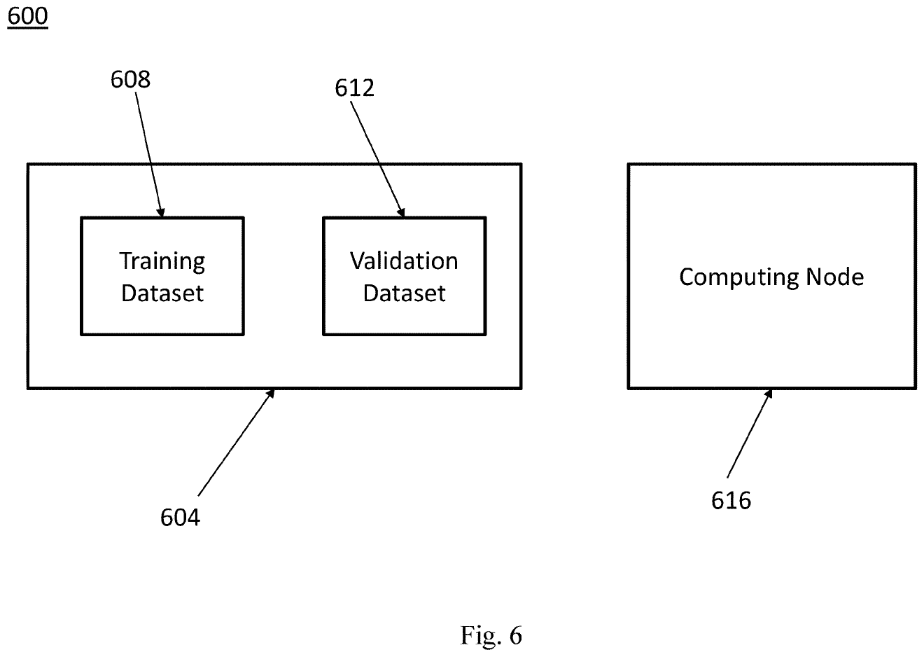

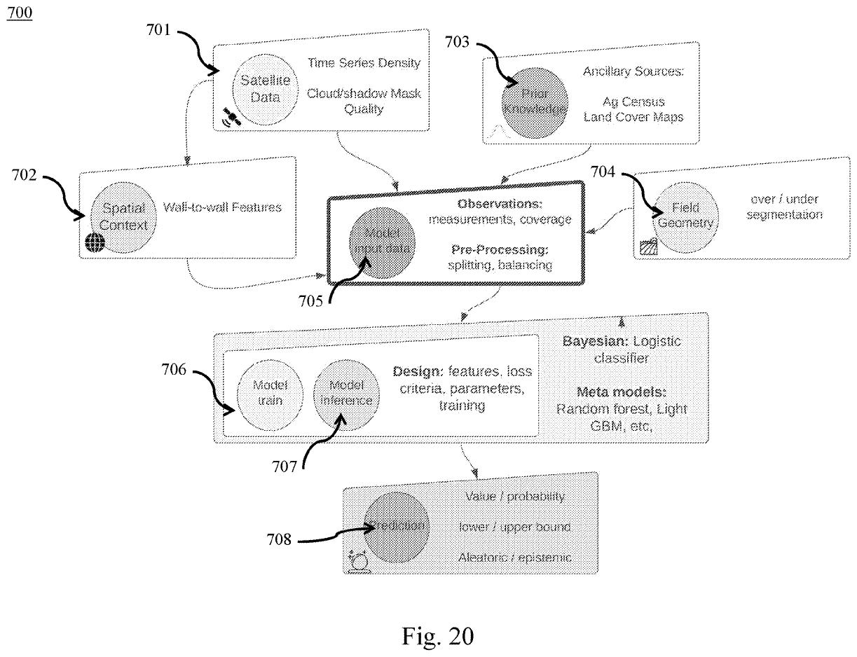

Referring to now to FIG. 6, a system 600 including one or more datastore 604 is shown in schematic form. Datastore 604 includes a training dataset 608 and a validation dataset 612, as described herein above. System 600 includes a computing node 616. The computing node 616 may include a computer readable storage medium having program instructions embodied therewith, the program instructions executable by a processor of the computing node to cause the processor to perform a method according to the disclosed subject matter herein. Computing node 616 may be the same or similar to the computing node of FIG. 20.

With continued reference to FIG. 6, a computer program product for predicting the uncertainty of a model output may be included in system 600. The computer program product includes a computer readable storage medium having program instructions embodied therewith, the program instructions executable by a processor to cause the processor to perform a method according to the disclosed subject matter. Any of the components described in relation to FIG. 6 may be the same or similar to components described in reference to FIG. 20, namely computing node, processor, program instructions, computer readable storage medium, and the like.

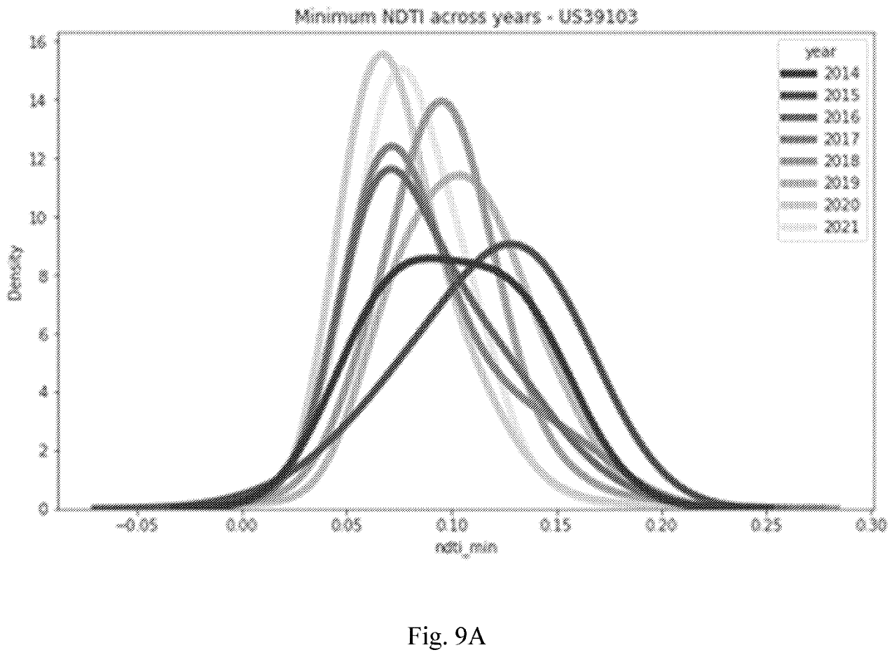

Referring now to FIGS. 9A-B, while ground truth labels of management practices (e.g., tillage vs. no tillage or cover crop vs. winter fallow) are instrumental in helping to quantify field-scale uncertainty, they are often scarce across particular geographic sub-regions or years. In such cases, confidence in model predictions is relatively low. Meanwhile, regional ancillary data sources such as the Ag Census survey or tillage transect data and wall-to-wall remote sensing-derived features may also be used complementarily to quantify uncertainty. Survey or transect data (e.g., from Indiana or Illinois) are typically aggregated to county scale to protect grower privacy and offer a reasonable prior estimate of adoption for a field. However, these data are usually only collected during a select number of years. The most basic remote sensing derived features that may be used to detect tillage and cover crops are the minimum dormant season NDTI (NDTIₘᵢₙ) and the amplitude of the second largest peak detected during the defined crop growing season (VIₐₘₚ), respectively. These features may be derived on an annual basis and provide a baseline approximation of (1) the amount of residue cover on the soil and (2) the magnitude of green vegetation growth in spring prior to planting of the main crop. Moreover, they provide useful context for how a particular field compares to its close neighbors with respect to these factors. If a field has a larger amplitude peak in late winter/early spring, then there's a higher likelihood of cover crop presence. Similarly, if a field has a lower dip in NDTI, then there's a higher likelihood residue cover was displaced via tillage.

As a further example, low NDTI observations typically signal a high confidence tillage event. However, because NDTI is noisy and is influenced by a range of factors, there are similar dips in NDTI for no-till fields (caused by factors not yet modeled). If there is a synchronized dip in NDTI across a range of neighboring fields (especially in counties that report low tillage rates in Ag Census), the confidence that a true tillage event occurred will decrease.

With continued reference to FIGS. 9A-B, the distribution of NDTIₘᵢₙ and VIₐₘₚ across a single county can vary significantly from year to year. This variability is driven by three main factors: (1) remote sensing observation density—sparser time series due to cloud cover or shadows may exclude information related to tillage events and/or plant growth; (2) weather—in particular, NDTI is known to be sensitive to moisture, while cover crop and weed growth is dependent on growing degree-days and precipitation; and (3) actual changes in adoption of management practices by growers. Combined with the county-level estimated prior of adoption rate, these features can be used to quantify uncertainty based on the following methodology.

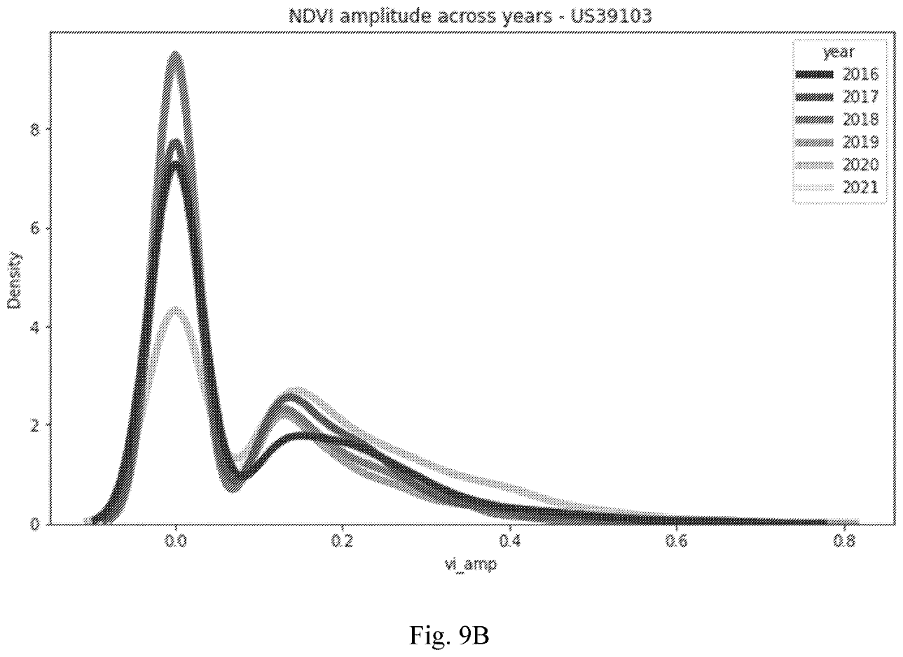

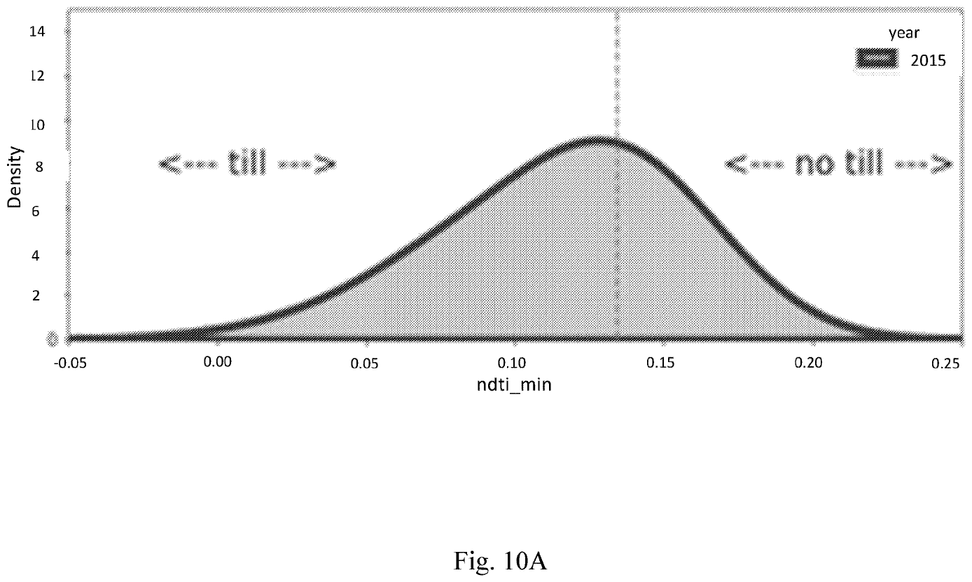

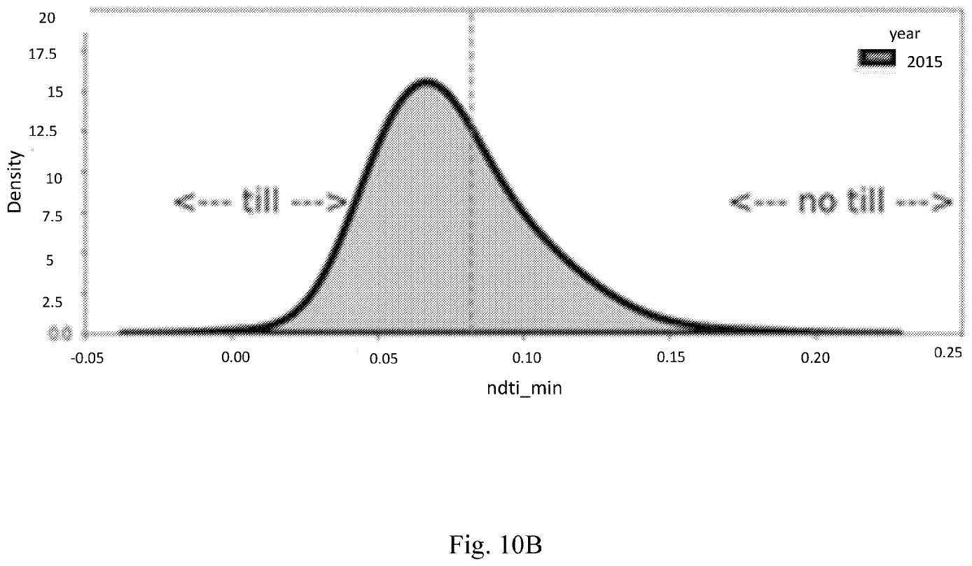

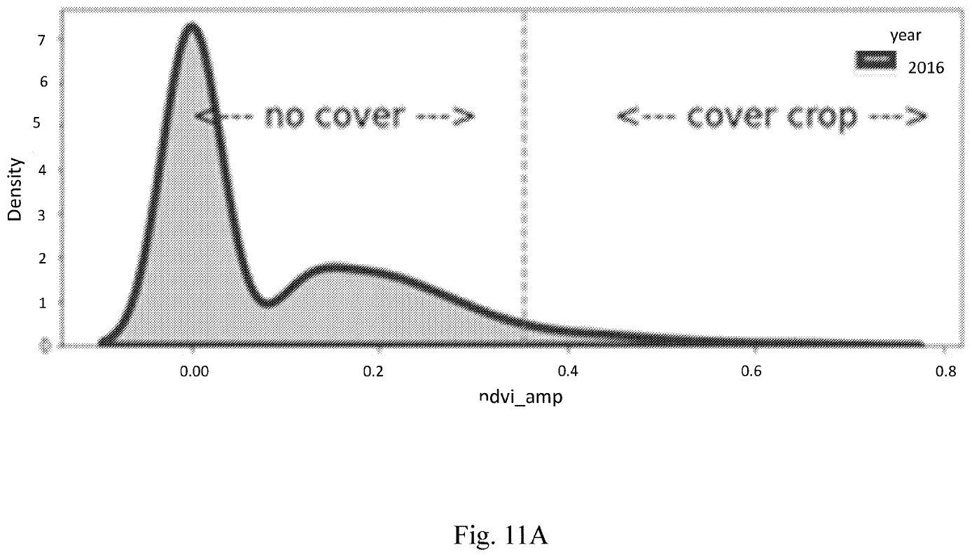

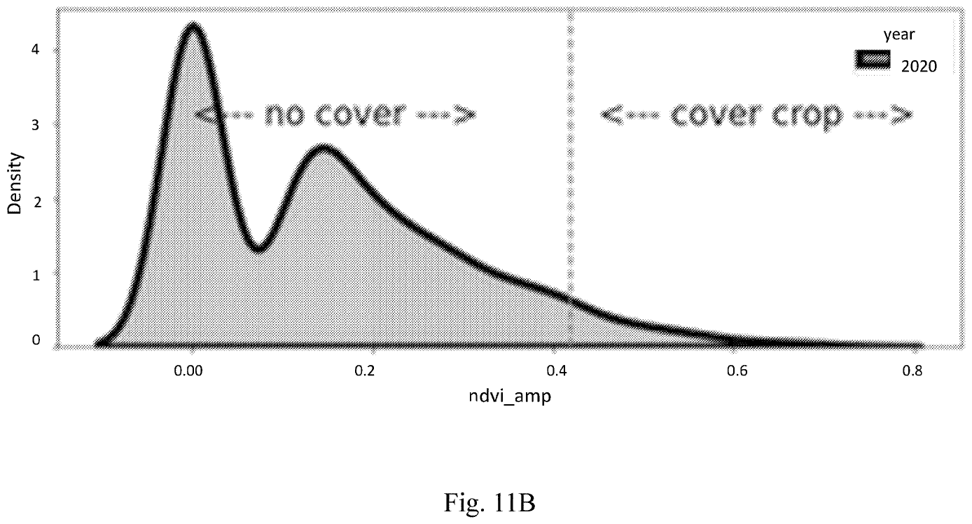

First, across a given county and year, the rank percentile score of NDTIₘᵢₙ and VIₐₘₚ of each field can be computed. Then, assuming the adoption rate is constant across years (or, if possible, transect results may be substituted in), the rate to estimate the magnitude of NDTIₘᵢₙ and VIₐₘₚ at which the transition from till to no till or no cover to cover may occur (see blue dashed lines in FIGS. 10A-B and 11A-B). In the case of cover crops, any fields classified as winter wheat, alfalfa, hay/pasture or double crop are excluded, which typically have relatively high late winter/early spring NDVI.

A variety of acronyms are used in this discussion as known in the art. These include CDL (Cropland Data Layer), HLS (Harmonized Landsat Sentinel), SMAP (Soil Moisture Active Passive), NDVI (Normalized Difference Vegetation Index), NDTI (Normalized Difference Tillage Index), SWIR (shortwave infrared), DOY (Day of Year).

The pigment in plant leaves, chlorophyll, strongly absorbs visible light (from 0.4 to 0.7 μm) for use in photosynthesis. The cell structure of the leaves, on the other hand, strongly reflects near-infrared light (from 0.7 to 1.1 μm). The more leaves a plant has, the more these wavelengths of light are affected, respectively. NDVI is calculated from the visible and near-infrared light reflected by vegetation. Healthy vegetation absorbs most of the visible light that hits it, and reflects a large portion of the near-infrared light. Unhealthy or sparse vegetation reflects more visible light and less near-infrared light. Accordingly, the NDVI is computed as near-infrared radiation minus visible radiation divided by near-infrared radiation plus visible radiation, or (NIR−Red)/(NIR+Red).

The NDTI is computed as (SWIR1−SWIR2)/(SWIR1+SWIR2). In exemplary embodiments utilizing Sentinel-2 MSI, Red, NIR, SWIR1, and SWIR2 represent bands 4, 8, 11, and 12, respectively. Spectral characteristics of the 2A and 2B sensors onboard the Sentinel-2 satellite are given below.

TABLE 2

| | S2A | | S2B | | | |
|---|---|---|---|---|---|---|
| | Central | Band | Central | Band | Spatial | |
| Band | wavelength | width | wavelength | width | resolution | |
| Number | (nm) | (nm) | (nm) | (nm) | (m) | Name |
| 1 | 442.7 | 21 | 442.2 | 21 | 60 | — |
| 2 | 492.4 | 66 | 492.1 | 66 | 10 | Blue |
| 3 | 559.8 | 36 | 559 | 36 | 10 | Green |
| 4 | 664.6 | 31 | 664.9 | 31 | 10 | Red |
| 5 | 704.1 | 15 | 703.8 | 16 | 20 | — |
| 6 | 740.5 | 15 | 739.1 | 15 | 20 | — |
| 7 | 782.8 | 20 | 779.7 | 20 | 20 | — |
| 8 | 832.8 | 106 | 832.9 | 106 | 10 | NIR |
| 8a | 864.7 | 21 | 864 | 22 | 20 | — |
| 9 | 945.1 | 20 | 943.2 | 21 | 60 | — |
| 10 | 1373.5 | 31 | 1376.9 | 30 | 60 | — |
| 11 | 1613.7 | 91 | 1610.4 | 94 | 20 | SWIR1 |
| 12 | 2202.4 | 175 | 2185.7 | 185 | 20 | SWIR2 |

Detecting tillage events with remote sensing relies on an ability to observe residue cover on fields. Fields with residue cover absorb more shortwave infrared (SWIR) radiation than bare soil, with greater absorption at longer SWIR wavelengths. The Normalized Difference Tillage Index (NDTI), which can be calculated with Landsat, Sentinel-2, and MODIS data, among others, can characterize this absorption feature of residue, allowing fields with residue (high NDTI) to be separated from fields with bare soil (low NDTI). However, a number of issues with detecting tillage events with NDTI.

First, NDTI is not sensitive to residue when green vegetation is present. When green vegetation is present on a field, NDTI is no longer sensitive to the amount of residue cover, as healthy green vegetation absorbs strongly in the short wave infrared (SWIR) portion of the spectrum (approximately 1400-3000 nm wavelength). In some embodiments, the methods described here address this by detecting till events when green vegetation cover is low. In some embodiments, by identifying and predicting tillage events during “dormant periods” where at least 2 consecutive observations have NDVI <0.3. In various embodiments, till events are only detected within these dormant periods. In various embodiments, if NDVI jumps above 0.3 for a single observation, then the observation is masked to prevent a single noisy observation from breaking up a dormant period. Dormant periods are optimally at least two weeks (alternatively, at least one month) in length, with calculated dormant periods typically spanning from harvest to planting the following year. If a cover crop is planted, there may be a dormant period on either side of the cover crop. In various embodiments, till events are detected in either or both dormant period.

An additional challenge is NDTI is strongly influenced by soil moisture. As water has strong absorption features in the SWIR bands, NDTI can be significantly influenced by soil moisture. This causes tilled fields with bare soil to resemble fields with high residue cover when fields are wet. In some embodiments, the methods described here address this by using soil moisture estimates from NASA's Soil Moisture Active Passive (SMAP) mission to screen NDTI observations on days when soil moisture is greater than a threshold percentage. In some embodiments, the threshold percentage is greater than 30%, 35%, 40%, 45%, or 50%. SMAP data are available from 2015 to the present at 9 km spatial resolution and a two day temporal frequency (although gaps exist). Once observations with high soil moisture are removed, a field is flagged as too wet to predict in the given year if fewer than two dry observations remain or a gap of more than 100 days between dry observations was created. In various embodiments, a field is considered high moisture is the moisture level is greater than the threshold for more than 75%, 80%, 85%, 90%, and 95% of observations during the dormant period or for all observations during the dormant period. In some embodiments, the threshold percentage is equal to or greater than 40% soil moisture. In some embodiments, the threshold percentage is equal to or greater than 40% soil moisture and fields are too wet to predict tillage practices if all of the observations have greater than the threshold percentage of soil moisture. The percentage soil moisture values or “soil moisture scores” are recorded for each dormant period, even where the soil moisture value is less than the threshold value (for example, <40%) as soil moisture values less than the threshold can still influence NDTI. The soil moisture score is recorded for each dormant period and later used to assess the quality of the till/no-till detection.

An additional challenge is atmospheric contamination can resemble a till event. NDTI can decrease and resemble a till event if an observation is contaminated by clouds or other atmospheric effects. While most clouds/noise are removed by preprocessing steps, a number of contaminated observations can remain in the time-series leading to false detection of till events. In some embodiments, the methods described herein screen for contaminated NDTI observations by identifying and removing from further analysis NDTI observations that deviate strongly from both the observation before and after the image (which may be referred to as despiking). Another factor which may be monitored for detecting contaminated observations is that residue cover should not increase in the winter. In another embodiment, the methods described herein screen for contaminated NDTI observations by identifying abrupt increases in NDTI between images, and flagging these observations and or removing then from further analysis. NDTI should only increase in this way following a till event if soil moisture increases. Therefore, if NDTI increases by >0.05 between observations and <5 mm of rain was recorded between observations, the low NDTI observation is removed.

In some embodiments, inputs to the tillage prediction model include NDTI and NDVI. In some embodiments, these indices are prepared by the following steps. Field-level zonal summary time series are generated for NDTI and NDVI. Observations are screened for snow using the Normalized Difference Snow Index (NDSI). Specifically, observations where NDSI is >0 are screened and removed from the analysis. Observations with <85% of available pixels are removed to prevent partially contaminated images from being included. Observations are “despiked”, if an image is a spike in either NDVI or NDTI, the image is removed for both.

Inputs to the tillage prediction model also include soil moisture data, precipitation data, and a crop type data layer. Soil moisture data may be obtained, for example, from SMAP. County- or field-level zonal summaries are calculated and interpolated to obtain time series of daily observations. Field-level zonal summary time series are generated for daily observations of precipitation. Field-level zonal summary time series of crop type are generated, for example from the USDA Cropland Data Layer (CDL), which provides annual predictions of crop type.

Referring to FIGS. 10A-B and 11A-B, the dotted line showing the prediction of the transition from till to no till or no cover to cover may be seen as a vertical line splitting the plot. Based on this magnitude (NDTI_{min_thresh}), fields are then re-classified as 1 if NDTIₘᵢₙ<NDTI_{min_thresh} (i.e., likely a till event) or 0 if NDTIₘᵢₙ>=NDTI_{min_thresh}. Similarly, fields are re-classified as 1 if VIₐₘₚ>=VI_{amp_thresh} (i.e., likely a cover crop) or 0 if VIₐₘₚ<VI_{amp_thresh}. Example results are provided in the table below for a sample of fields from the same county-year:

TABLE 2

| | geo_id | year | ndti_min | ndti_min_score | reclass |
|---|---|---|---|---|---|
| 1445 | US39103_fe4995fdBcfc08629d699cf0dec4bf70 | 2021 | 0.11615 | 0.911959 | 0.0 |
| 1446 | US39103_fe7bcb9a4c61e1c80cb094af10cc6bf9 | 2021 | 0.07560 | 0.449010 | 1.0 |
| 1447 | US39103_fe908f36b4f9e34d0acb5e5d85086be8 | 2021 | 0.06694 | 0.258254 | 1.0 |
| 1448 | US39103_fe9b623d07ecdd0cd1f005d9906b0ebc | 2021 | 0.16149 | 0.996332 | 0.0 |
| 1449 | US39103_fedb0ed2202c45015abe0844e20b8abf | 2021 | 0.09283 | 0.704329 | 0.0 |
| 1450 | US39103_feeBeaf4c33b68fe4456f5e2302e027b | 2021 | 0.08723 | 0.628026 | 1.0 |
| 1451 | US39103_ff2954898c719daf266063858c60e220 | 2021 | 0.08562 | 0.595745 | 1.0 |
| 1452 | US39103_ff4720b4e77489cd47c184d64c204feb | 2021 | 0.04397 | 0.062362 | 1.0 |
| 1453 | US39103_ff8159e963dec359d3689be5f9832de2 | 2021 | 0.08950 | 0.656640 | 1.0 |
| 1454 | US39103_fffbde2b0dd94f61e373defe9993bd39 | 2021 | 0.03572 | 0.027880 | 1.0 |

Using the re-classified labels shown in the immediately preceding table in accordance with methods here described, a logistic function can be estimated, while generating posterior distributions of each parameter, represented by the below function:

def logistic(x,beta,alpha=0): return 1.0/(1.0+pp.exp(np.dot(beta,x)+alpha))

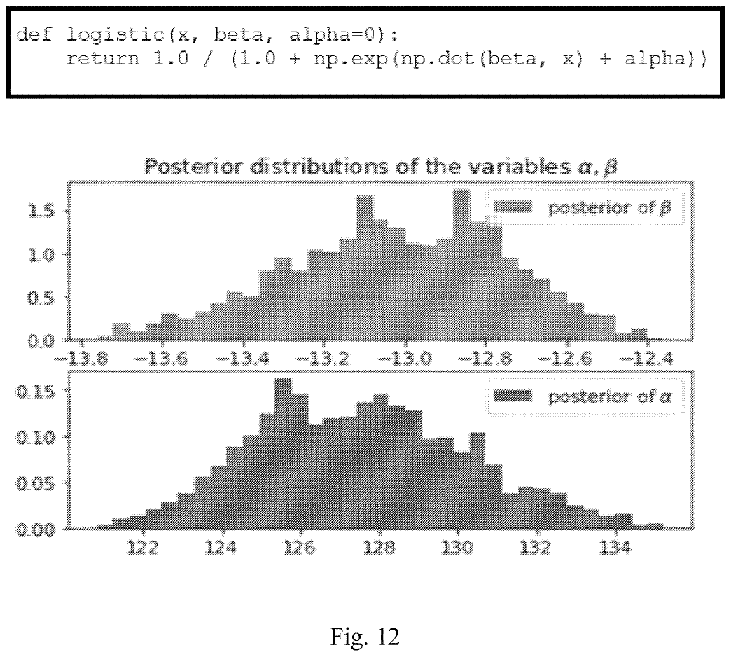

and the posterior distributions of the variables alpha and beta above can be seen in FIG. 12.

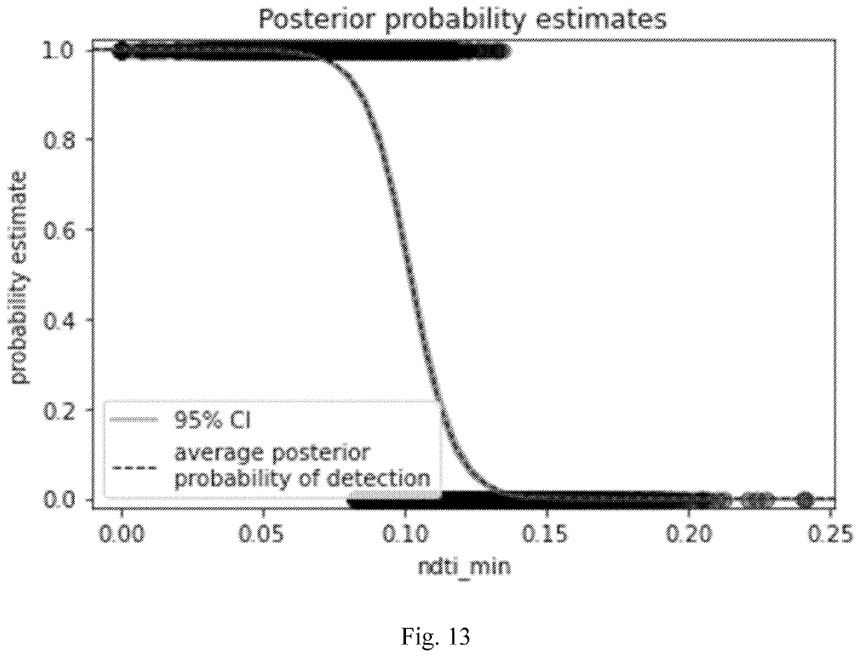

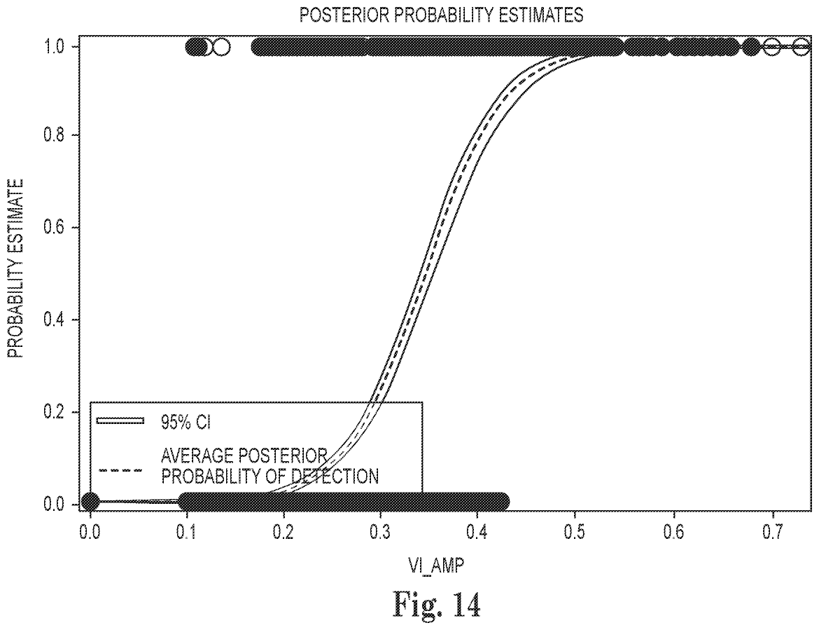

Based on the mean and variance of these posterior distributions, the probability of till vs. no till or cover vs. no cover can be quantified for an individual field during a single year based on the magnitude of NDTIₘᵢₙ or VIₐₘₚ. For example, in the example shown in FIGS. 13 and 14, if a field has NDTIₘᵢₙ=0.1, there is a 56.5% chance that it was tilled, while if NDTIₘᵢₙ=0.075, there is a 97.5% chance that it was tilled.

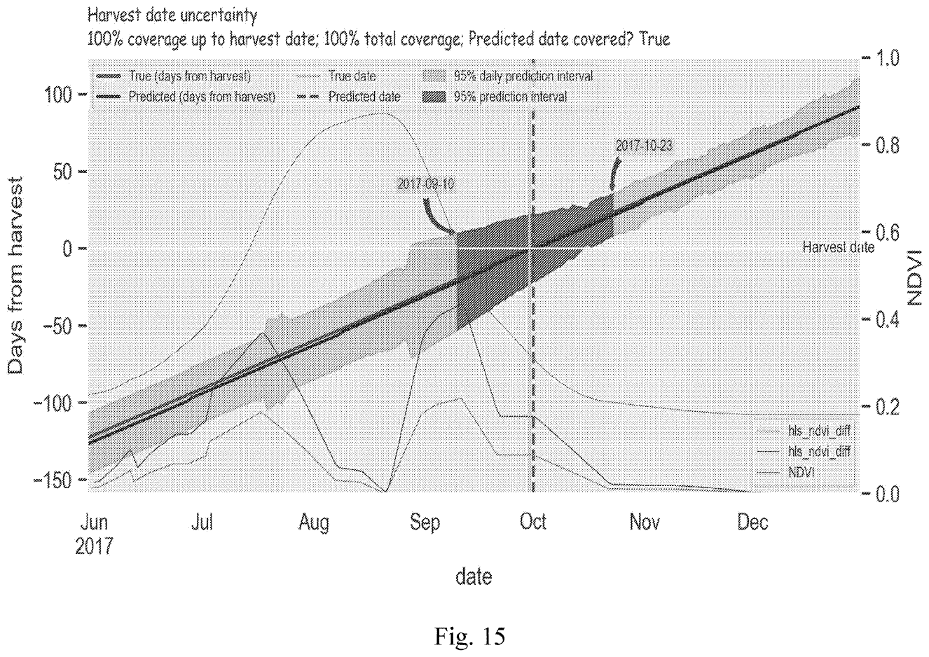

Referring now to FIG. 15, a plot of temporal uncertainty is shown. Temporal uncertainty can be ascertained visually from the data represented by this plot. Any of this data may be used to train, validate, or otherwise improve one or more machine learning models consistent with this disclosure. Temporal uncertainty can refer to harvest date uncertainty at the field level. 95% certainty bar may be represented in one or more lines that bound the true days from harvest vs the predicted days from harvest, increasing in NDVI and days from harvest, over time. The true harvest date and predicted date can be seen as two vertical lines bisecting the plot in about October.

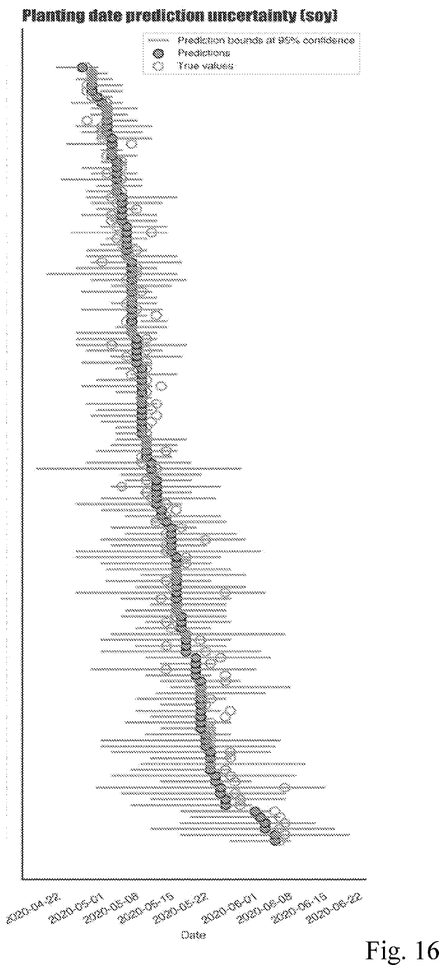

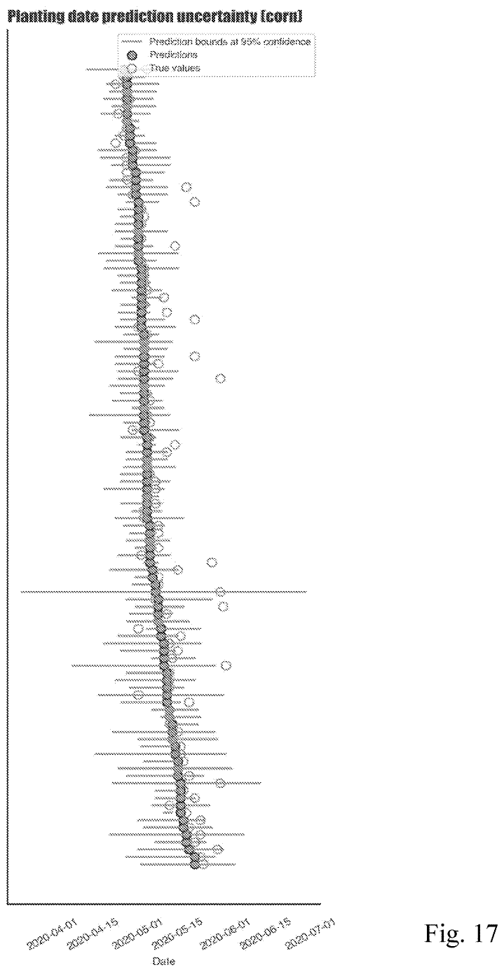

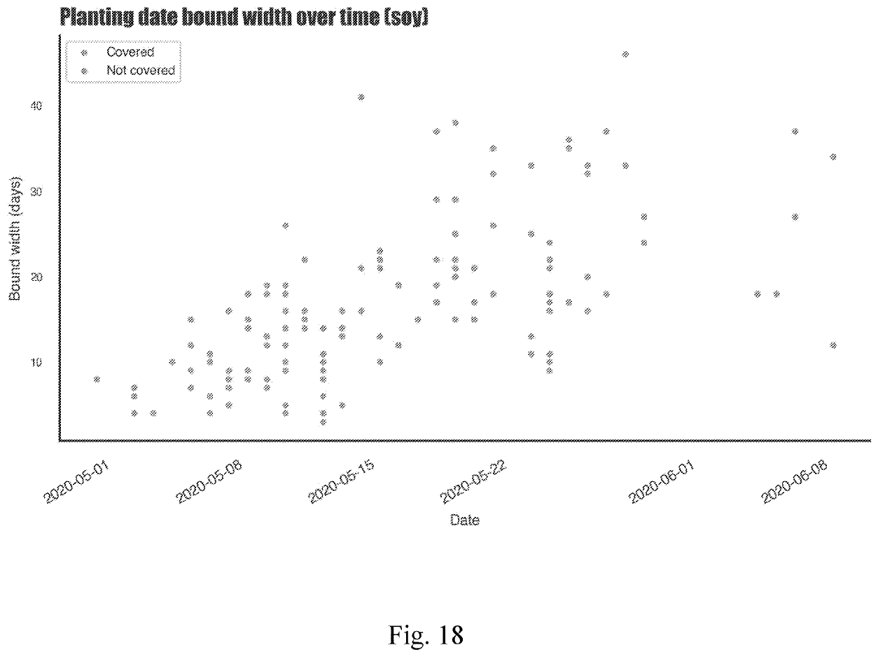

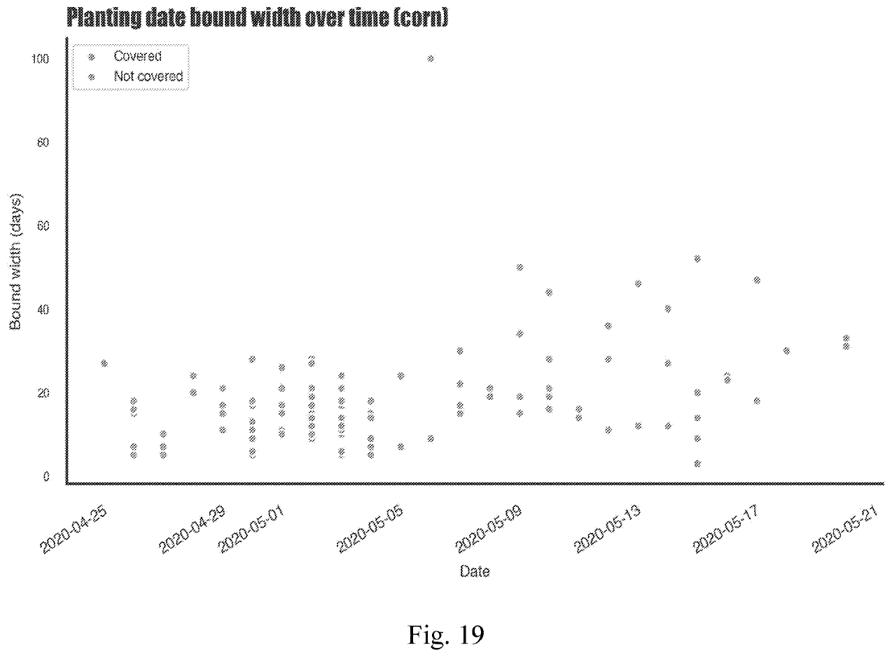

Referring now to FIGS. 16 and 17, planting date prediction uncertainty for soy (FIG. 18) and corn (FIG. 19) can be seen. The plots shown prediction dates versus true dates, and the 95% confidence bounds represented by a bar associated with each plot, herein identified with a plot number. The results clearly show that the 95% confidence bars bound every true value, and in most plots, the predicted value and true value are relatively close within the 95% confidence bars.

Similarly, FIGS. 18 and 19 are scatter plots identifying bound width (in days) of the confidence bars from FIGS. 16 and 17, over time. FIG. 18 shows planting date bound width over time for soy and FIG. 19 shows planting date bound width over time for corn.

### Additional Examples

FIG. 20 is an exemplary overall workflow 700 for predicting an uncertainty of a machine learning model. The workflow 700 includes drawing inputs from a plurality of resources, including satellite data 701, spatial context 702, prior knowledge 703, and field geometry 704. Satellite data 701 can include time series density, for example, or cloud/shadow mask quality. Spatial context 702 can include wall-to-wall features. Prior knowledge 703 can include ancillary sources, such as an Agricultural (Ag) Census or land cover maps. Field geometry 704 can indicate over/under segmentation. These inputs can be gathered as model input data 705. Model input data 705 can include observations such as measurements and coverage, and pre-processing steps such as splitting and balancing. Model input data 705 can be input into a model for model training 706, or model inference 707. The model design may include features, loss criteria, parameters and training. The model can be a Bayesian logistic classifier, or a random forest, light GBM, etc. The output of the model, prediction 708, can include a value or probability, a lower or upper bound, or an Aleatoric or epistemic uncertainty.

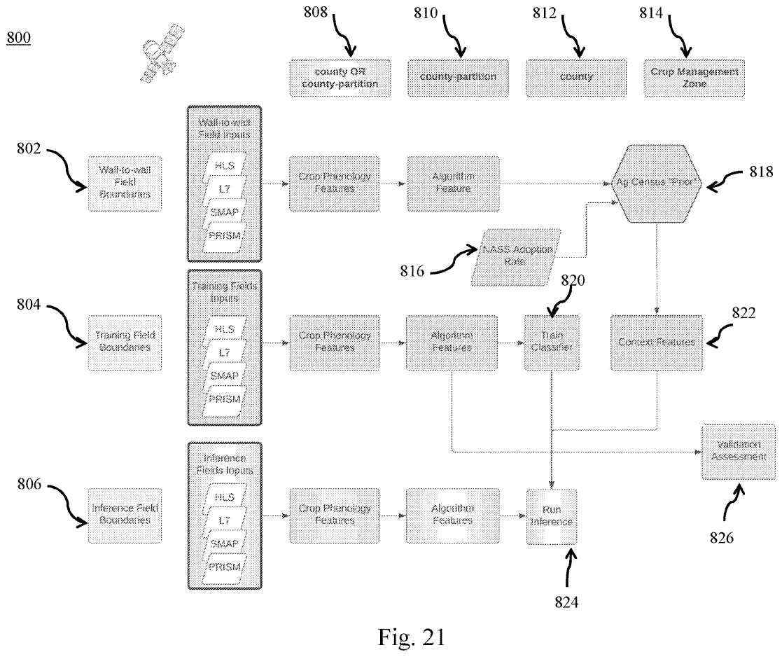

FIG. 21 is an exemplary workflow 800 for a single algorithm. Here, exemplary workflow 800 comprises a number of inputs, such as wall-to-wall field boundaries 802, training field boundaries 804, and inference field boundaries 806. Each corresponding input may comprise, e.g., an HLS, L7, SMAP, and/or PRISM files. The wall-to-wall field inputs 808 are provided at the county-partition level, the training fields inputs 810 are provided at the county level, and the inference fields inputs 812 are provided at either the county level or the county-partition level. In each case, crop phenology features 814, 816, 818 are extracted and used to determine algorithm features 820, 822, 824, each at the same level as the corresponding inputs. Algorithm features are then used in combination with National Agricultural Statistics Service (NASS) adoption rate data (which is provided at the county level) 826 to determine an Ag Census Prior 828 (also at the county level). From the Ag Census Prior 828, Context Features 830 are determined. Algorithm features 822 are used at 832 to train a classifier and for Validation Assessment 834 at the crop management zone level. The trained classifier is used to run inference on algorithm features 824 at step 836 using context features 830.

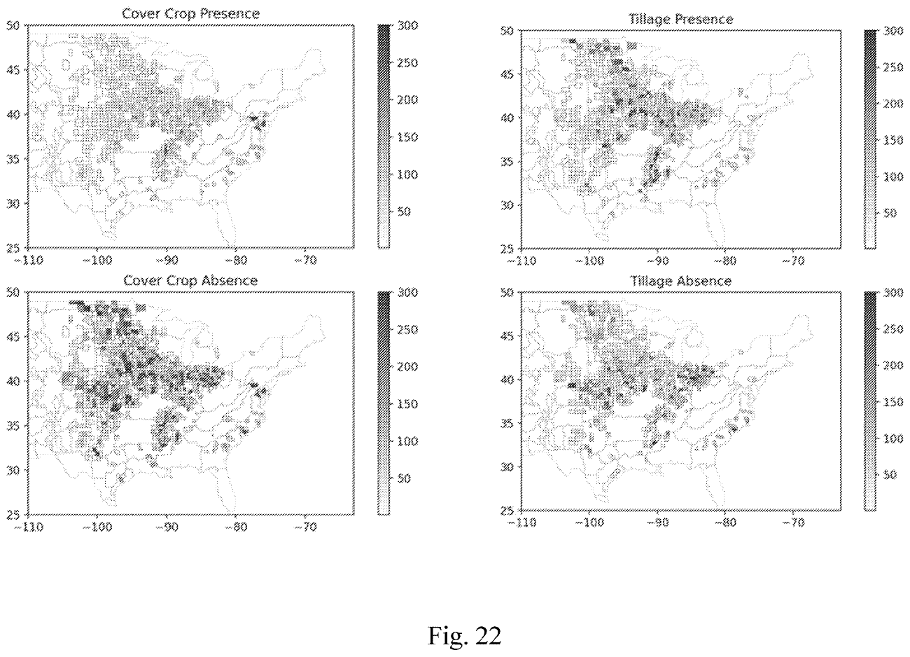

FIG. 22 is a series of graphs illustrating training data. More than 83,000 tillage and 101,000 cover crop training fields are represented by the training data. Data was collected from 2016-2022. The training data was assembled from window scouting, in-field soil sampling, and enrolled Carbon growers.

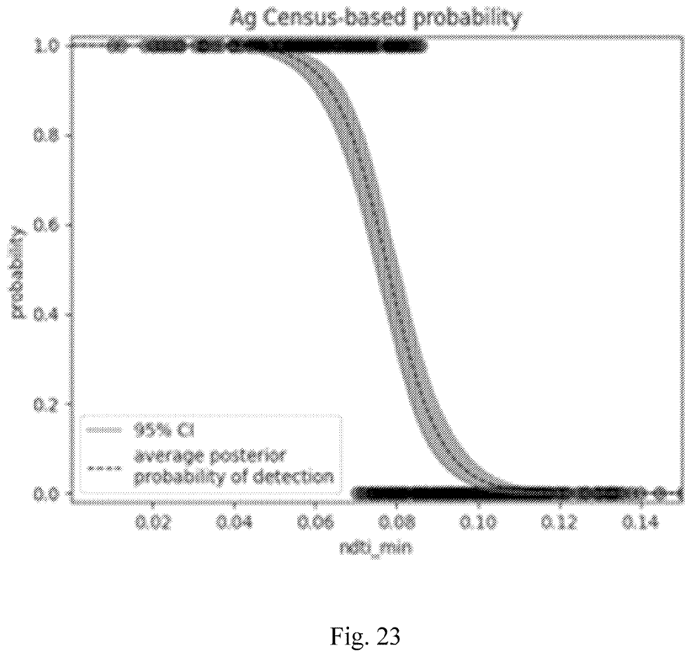

FIG. 23 is a plot of posterior probability estimates vs. NDTI.

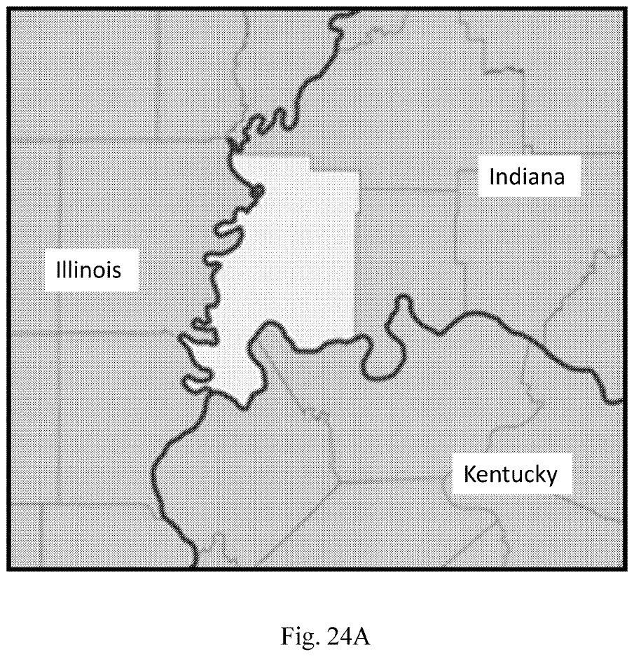

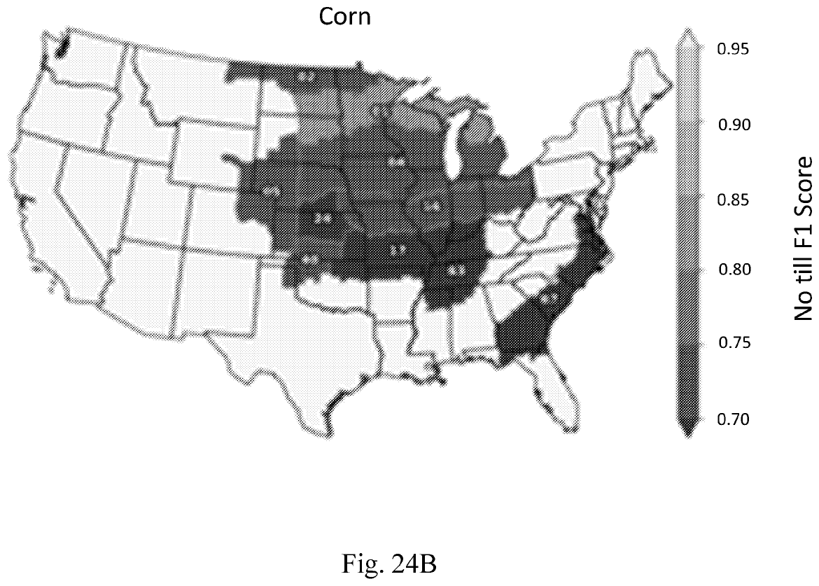

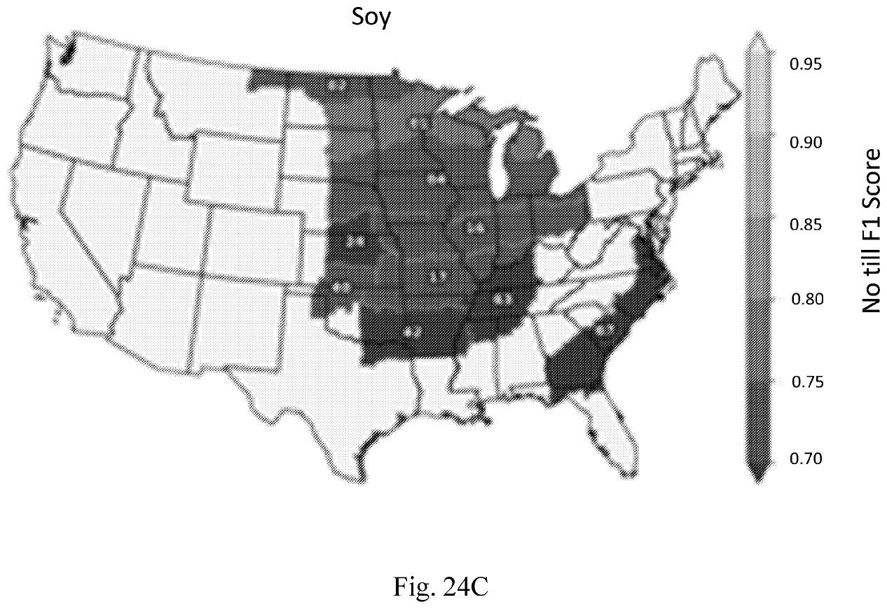

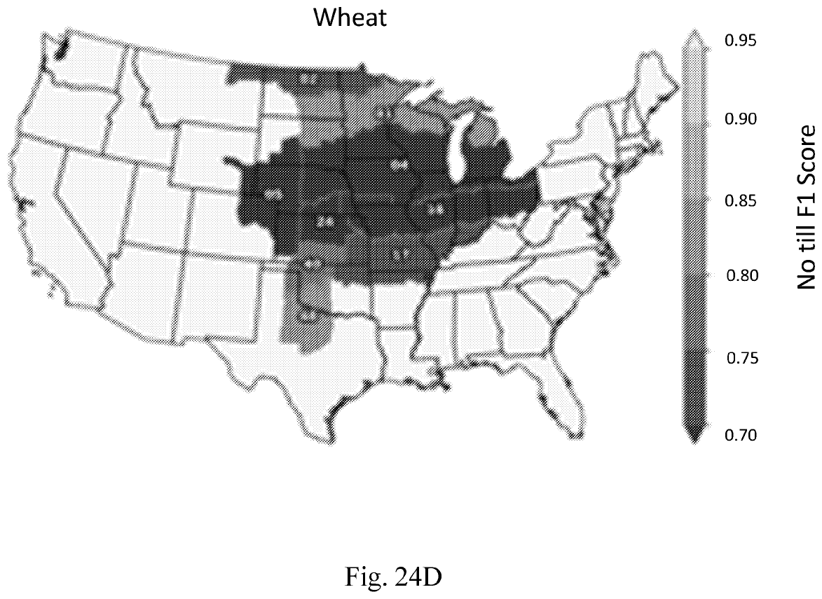

FIG. 24A is a map of generated inference results for wall-to-wall boundaries across Posey County, Indiana.

FIG. 24B-D are nationwide validation statistics for corn (FIG. 24B), soy (FIG. 24C), and wheat (FIG. 24D)

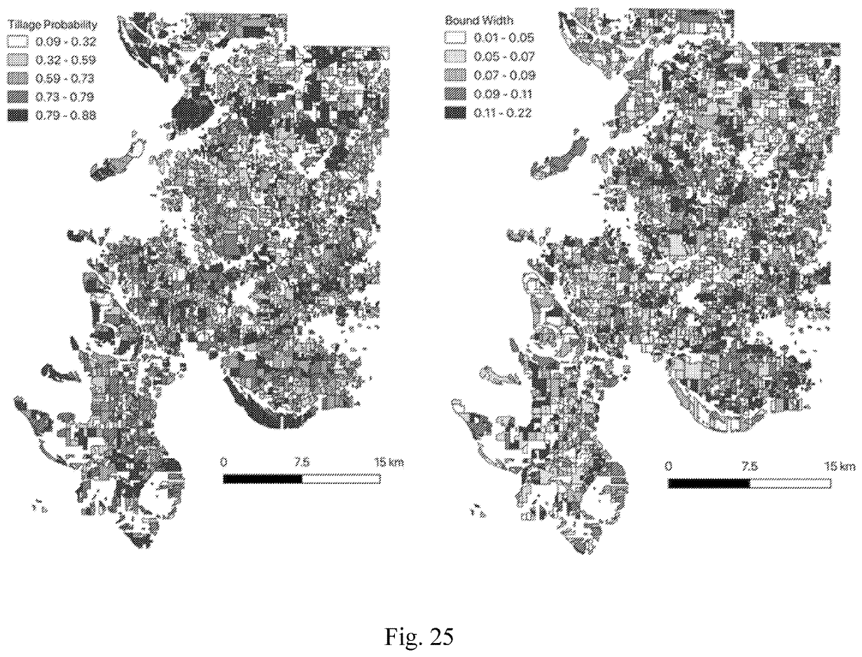

FIG. 25 is two maps showing the probability of tillage detection (left) and associated width of uncertainty bounds (right) across Posey County, Indiana, in 2021.

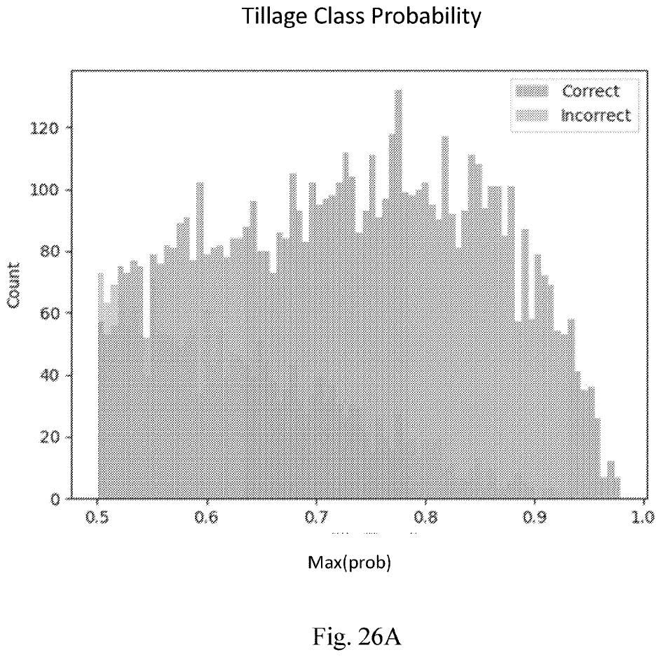

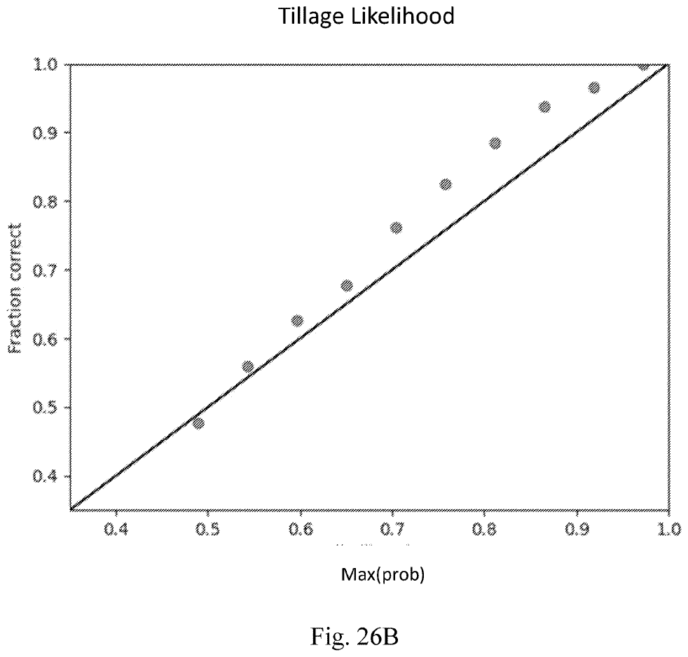

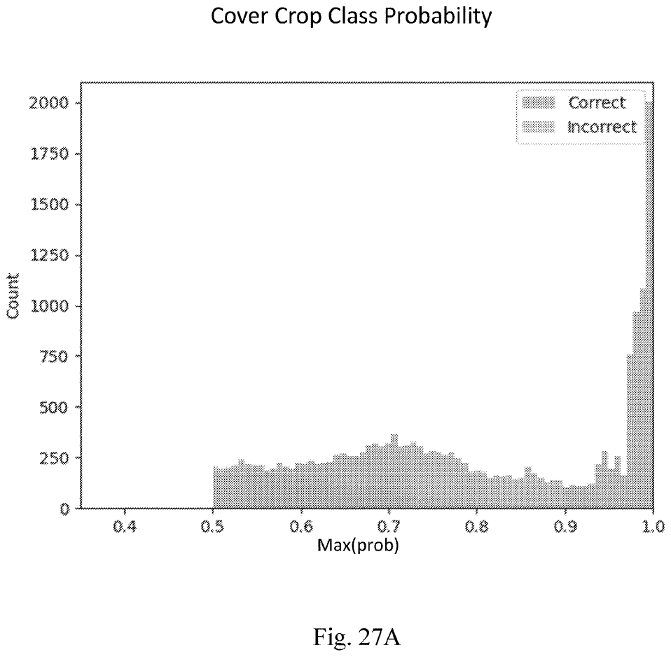

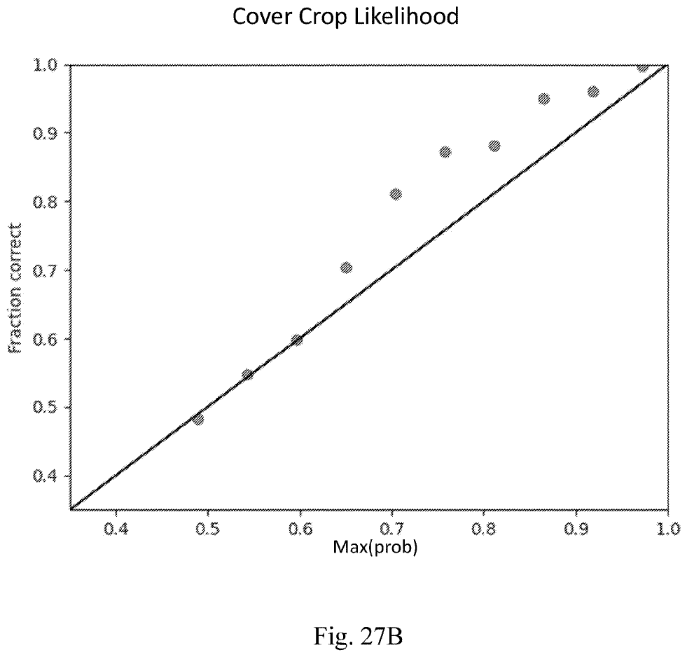

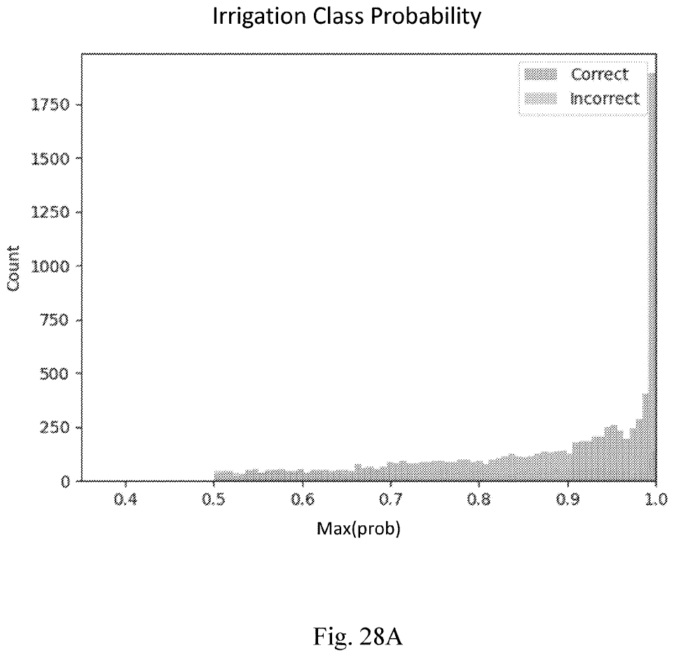

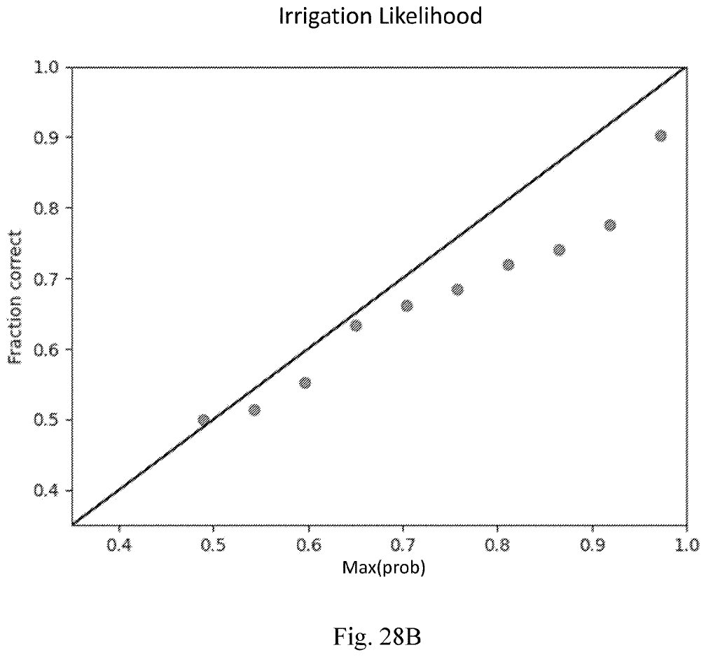

FIGS. 26-28 illustrate exemplary class probabilities and likelihoods derived according to the methods provided herein. FIG. 26A is a graph of class probability for tillage leading to FIG. 26B, a likelihood for tillage. FIG. 27A is a graph of class probability for cover crop leading to FIG. 27B, a likelihood for cover crop. FIG. 28A is a graph of class probability for irrigation leading to FIG. 28B, a likelihood for irrigation.

### Impact of Likelihood Thresholds for Wall-to Wall Classifiers

Given a specific probability threshold applied to an arbitrary field, the chance that the field will be below threshold depends on the threshold. Using exemplary wall-to-wall runs, the number of field-seasons that will be below threshold is estimated in the table below.

TABLE 4

| | Tillage | Cover crop | Irrigation |
|---|---|---|---|
| Total field/seasons | 28.782,490 | 38,383,080 | 27,004,822 |
| No prediction/not supported | 24% | 11.5% | 1.0% |
| Below 0.5 | 0% | 0% | 0% |
| Below 0.6 | 19.9% | 5.5% | 3.1% |
| Below 0.7 | 41.2% | 14.3% | 7.0% |
| Below 0.8 | 62.5% | 24.7% | 11.4% |
| Below 0.9 | 74.7% | 31.0% | 17.4% |

When compared with the agricultural area lost with alternative CMZ-based thresholds, these parameters and output predictions provide better spatial detail and also result in better coverage overall.

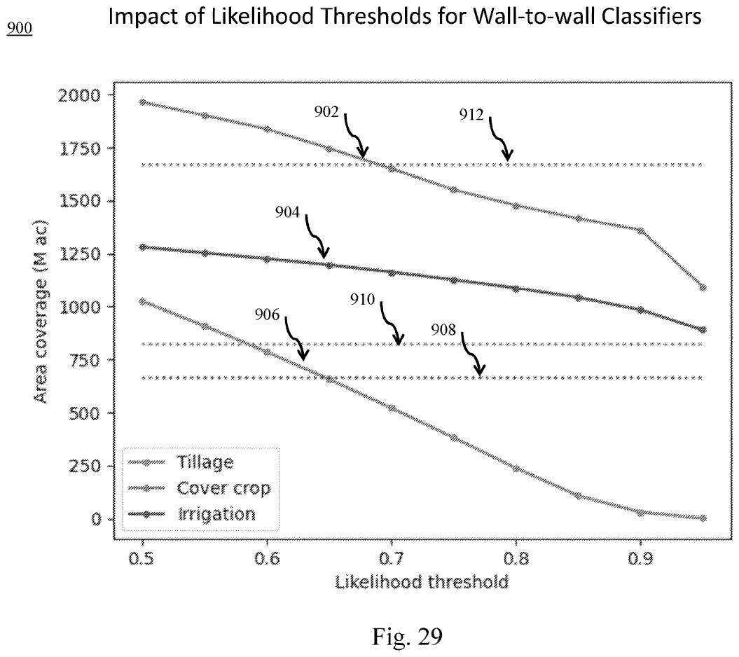

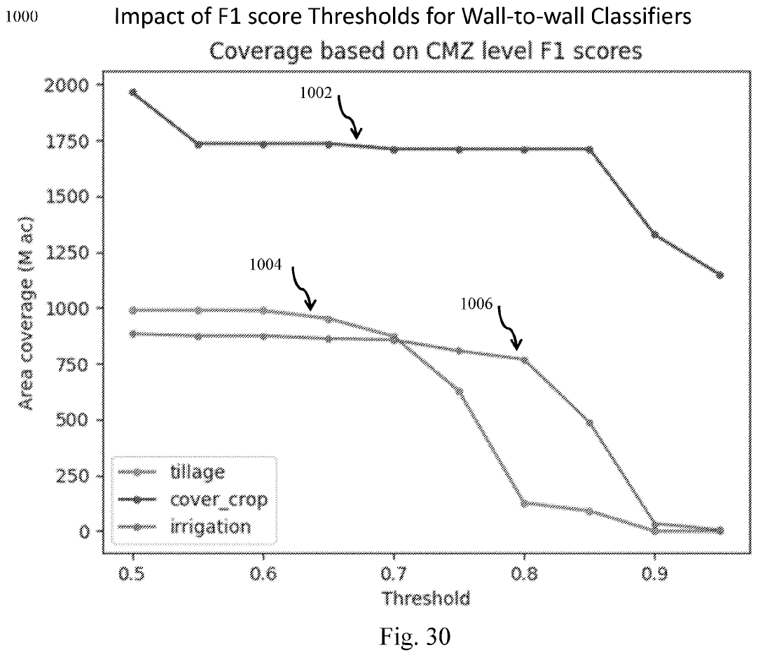

Given a specific probability threshold applied to an arbitrary field, it may be determined how much total field area will be above threshold. Exemplary results using the wall-to-wall runs are shown in graph 900 in FIG. 29. Cover crop results are shown by line 902, irrigation results shown by line 904, and tillage results are shown by line 906. Area coverage for irrigation practice that would result from setting an F1 score threshold of 0.7 are shown by line 908. Area coverage for tillage practice that would result from setting an F1 score threshold of 0.7 are shown by line 910. Area coverage for cover crop practice that would result from setting an F1 score threshold of 0.7 are shown by line 912. Using the likelihood as defined herein brings in fields across all CMZs, whereas using an F1 score completely screens out some CMZs. Likelihood provides a more granular filter. In comparison, given a specific F1 score threshold applied to an arbitrary CMZ, it may be determined how much total ag field area will be above threshold. Results using the same wall-to-wall runs as in the previous figure are shown in graph 1000 in FIG. 30. Here, cover crop results are shown by line 1002, tillage results are shown by line 1004, and irrigation results are shown by line 1006.

### Adjusted Likelihood

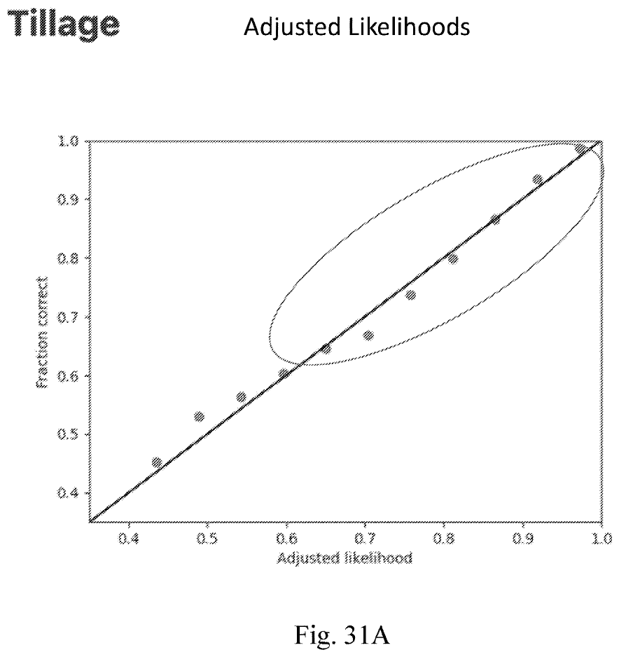

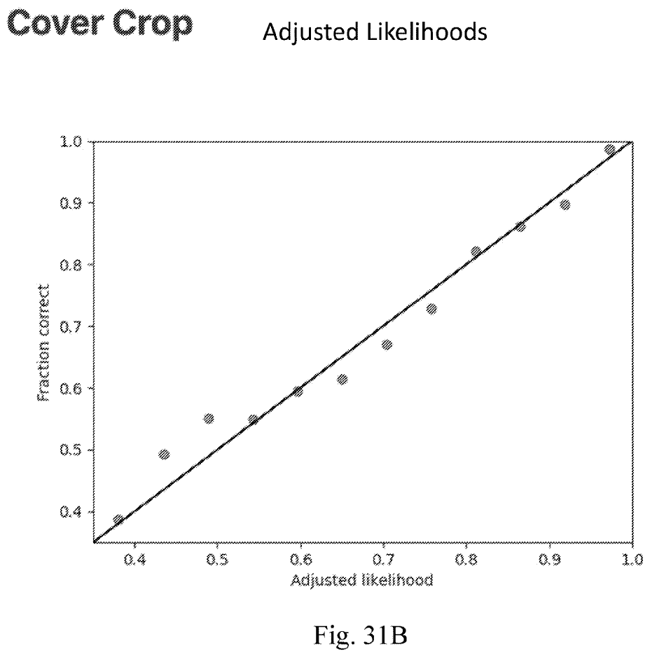

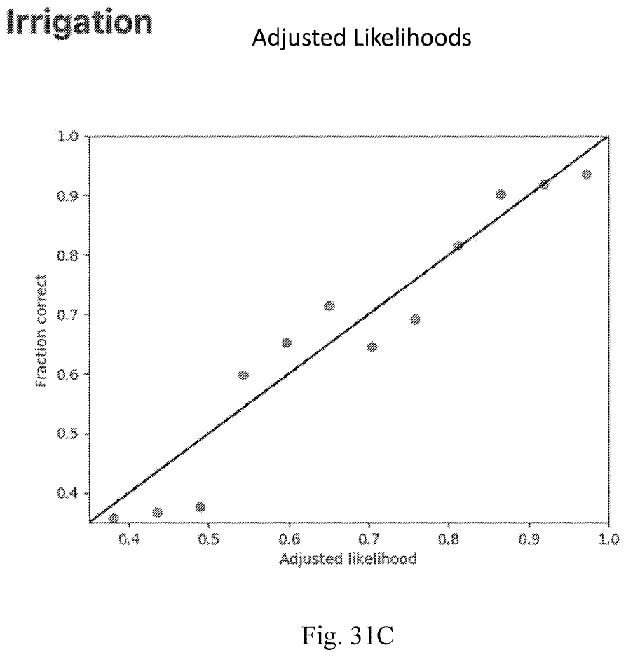

In this example, validation dataframes and a logistic regression model are used to calculate a new metric. The validation dataframes are defined as the model inference prediction, probabilities, and actual observed outcome obtained by iteratively holding out samples for every value in the training set (tens of thousands of samples). For the logistic regression model, a model is constructed that predicts whether predictions are right or wrong using the dataframe, with additional predictor variables being things that could affect whether the prediction is correct, e.g., field area, data quality, etc. Adding an additional modeling layer for “correctness” shows some improvement, as can be seen in FIG. 31A-C as compared to FIGS. 26-28 (for example see the region within the oval area labeled A in FIG. 31A).

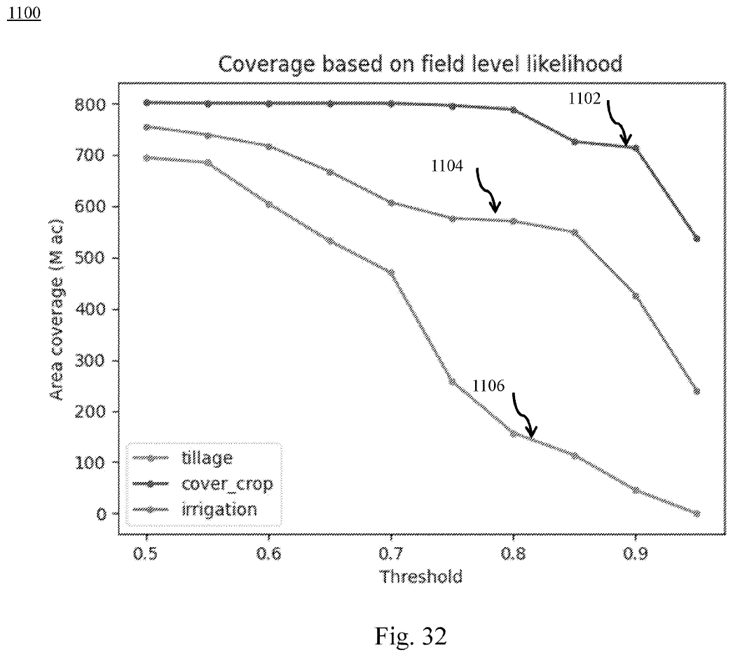

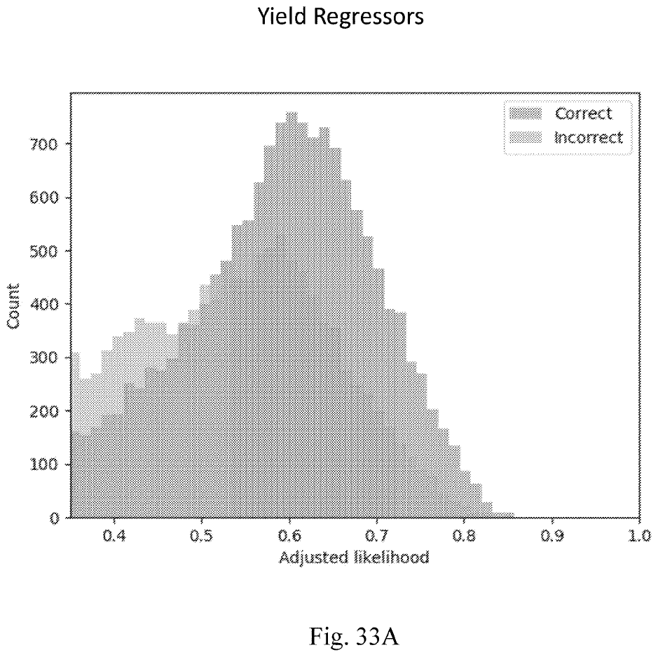

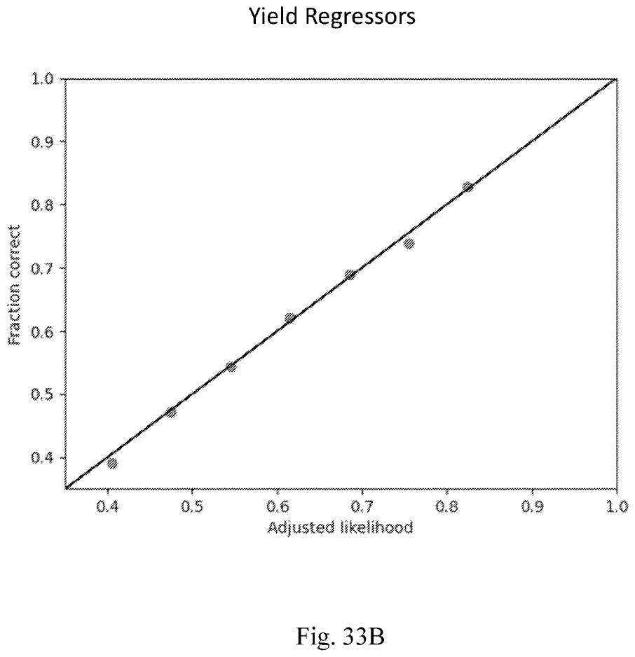

In the following discussion, the adjusted likelihood is referred to as likelihood. The threshold area tradeoff for this likelihood is illustrated in graph 1100 in FIG. 32. This same process may be followed with respect to regressors, but it introduces a new arbitrary parameters for cover crops (as shown in line 1102), irrigation (line 1104), and tillage (line 1106). For example, the likelihood that the algorithm result is within X % of the true value can be modeled. An example is shown in FIG. 33A-B for yield, where the chances that the result is within 10% are modeled.

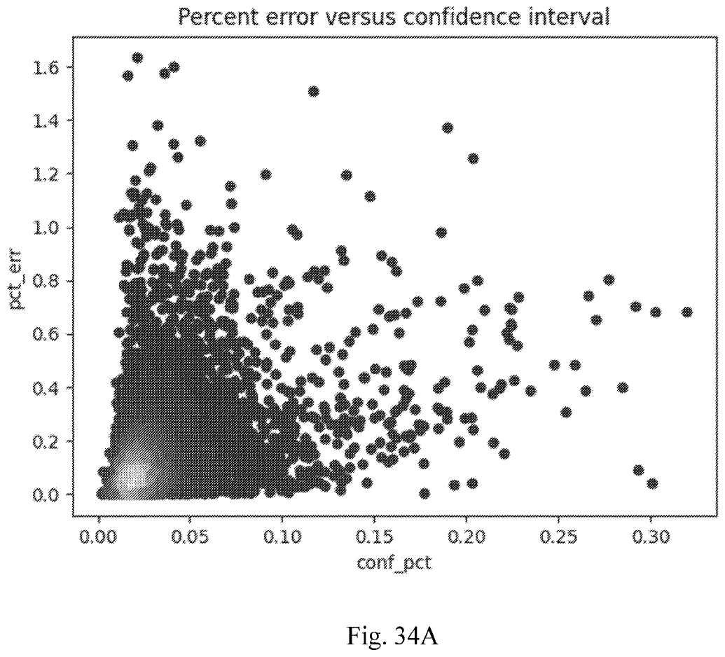

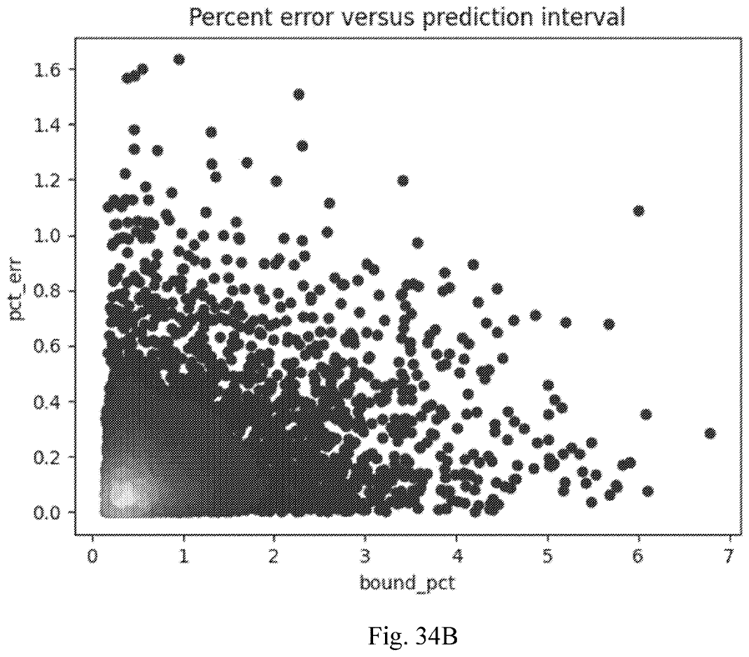

Confidence interval and predictions interval do not provide information about individual observations. As shown in FIG. 34, the percent error vs. prediction interval is too widespread to provide useful information about individual observations.

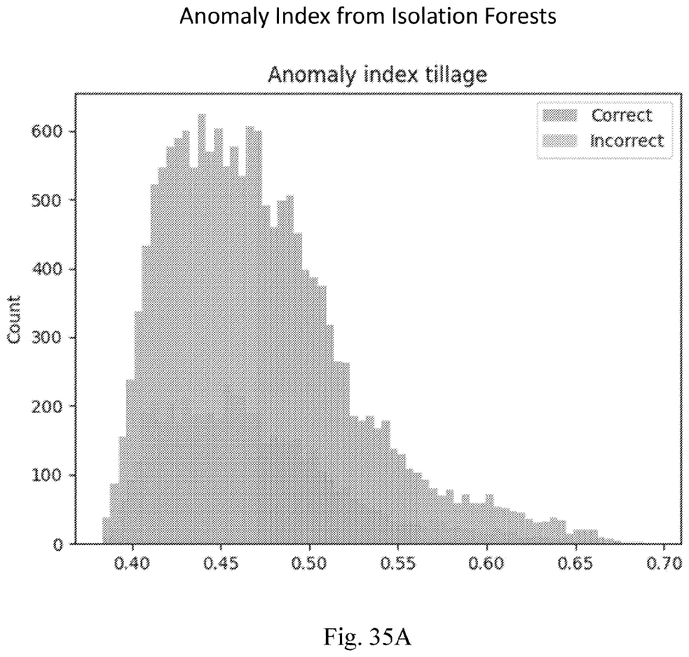

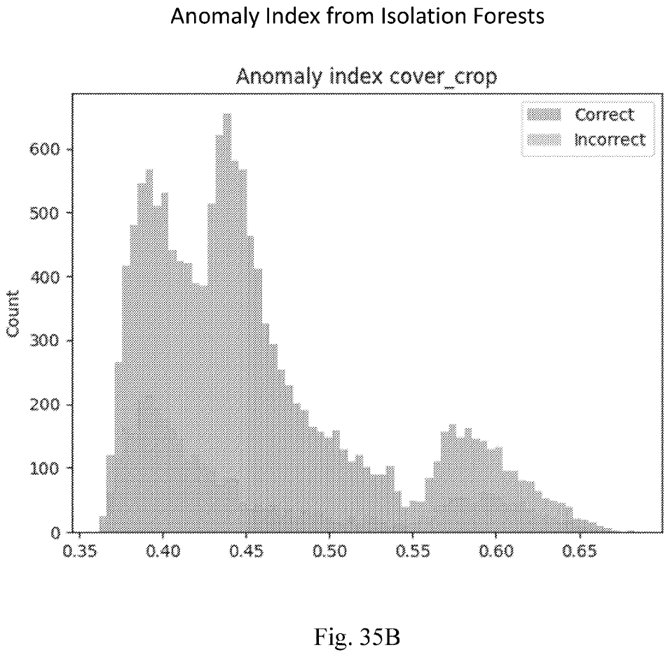

A boundary in feature space can be defined such that an “out of range” novel input can be flagged. A new input that is so unusual that it is not represented in the training data set should be flagged as being a potential outlier. For efficiency, this indicator can be combined with the likelihood metric, i.e., set to NaN for these cases, or returned as a separate piece of information. This boundary can be calculated by isolation forests producing a boundary and a quantitative anomaly index. A convex hull in a large number of dimensions is computationally prohibitive, which leads to the use of the isolation forest. The anomaly index from the isolation forests is shown in FIG. 35A (tillage) and FIG. 35B (cover crop). The anomaly index is not necessarily related to accuracy: there is a similar distribution of correct and incorrect responses and the similar proportion correct above and below index of 0.5, both of which are expected because all values in the exercise are within the training data set.

Regional (CMZ based) out of sample validation scores provide a way to evaluate the quality of a model and to decide whether to use the result or not. For classifiers, event-level likelihoods provide finer granularity, but they are also an estimate. For regressors, no unambiguous indicator of event-level quality was found; 95% prediction bounds are a reasonable indicator of the distribution of outcomes. For all algorithms, anomaly scores indicate when novel inputs are present. Choice of thresholds to use to determine quality of a model or of a specific result may be determined through stakeholder-specific tradeoffs.

### Guide to Uncertainty Data

In various embodiments, remote sensing inference outputs contain two columns that provide information on the quality of field-scale results: likelihood and anomaly_index. These columns can be used together with, or instead of existing aggregate measures (e.g., F1 score) to determine quality and thus usability of the individual predictions. As discussed above, the choice of thresholds to apply to these metrics is driven by tradeoffs that will help the downstream user to make that decision.

Remote sensing practice detection models contain errors, the magnitude of which can be estimated indirectly. Model validation is one such means, which produces spatially aggregated accuracy statistics. In addition, practice detection inference outputs include field scale estimates of accuracy and other information relative to the likely performance of the models. Embodiments of the present disclosure describe that information and provide guidance on its use. In various embodiments, this information is used to complement usage of alternative aggregate statistics (e.g., F1-score).

Relevant remote sensing algorithms for this discussion include, but are not limited to: Tillage detection; Cover crop detection; Irrigation detection; Crop yield; Harvest date; and Planting date.

An important distinction between the first three (detection) algorithms and the others is that they are trained on categorical data, i.e. a class label indicating whether the event occurred or not. The resulting prediction is thus, for example, till or no-till in the case of the tillage algorithm, or cover crop or no cover crop in the case of the cover crop algorithm. The detection algorithms can thus be validated exactly as to whether they are correct or not, as opposed to the quantitative algorithms, which can provide estimates (e.g., yield) which are either near or far from the true value.

For all the algorithms, a large ground truth data set is derived from a variety of sources, such as records from growers participating in ecosystem credit programs. These data are used for model training and validation. In exemplary embodiments, the model evaluation process utilizes 10-fold cross validation in which withheld (out of sample) data is iteratively compared to the predictions, and so for each ground truth record it is determined what the model would have predicted. This yields a field-scale measure of accuracy, but only for the ground truth (training) data fields. For the detection algorithms, it is possible to see whether the algorithm was correct (e.g., the prediction was cover crop and the observation was cover crop) or incorrect (e.g. the prediction was till and the observation was no-till). Thus, for these algorithms, validation information is used to estimate the likelihood that a new inference is correct or not. In exemplary embodiments, this is provide as the likelihood column (discussed below).

One important aspect of our ground truth data is that despite how extensive coverage is (hundreds of thousands of records across thousands of counties), only a tiny proportion of fields are being sampled. Therefore, any new field for which inference is being performing may or may not have experienced similar environmental conditions (in timing or in magnitude) as other fields that the model has previously been trained on. One way to describe these conditions is through the model features that are used in training. The model features are algorithm-specific combinations of remote sensing, weather, and/or other geophysical data that are used to train the models. Thus, for all the algorithms, the features are used as a way to determine to what extent a new field is unusual or not. In various embodiments, this is provided as an anomaly_index column (discussed below).

The likelihood value is an estimate of the probability that the modeled result is correct. The anomaly index is a measure of how unusual the field is compared to the fields that were used to train the model.

### Review of Aggregate Statistics

Cross validation provides the most straightforward estimate of algorithm performance, —how accurate the model prediction was when compared with held out data. However, the cross validation statistics are computed as an aggregate measure across large numbers of fields, essentially all the fields within a USDA crop management zone (CMZ). Model performance measures derived from validation include accuracy, precision, recall, and F1 score, with F1 score being a typical single value that is reported as it is less sensitive to unbalanced data. The CMZ-based F1 is useful as a way to track model performance. In exemplary embodiments, a threshold F1 score of 0.7 is applied for the detection algorithms. In such embodiments, if the F1 score for the CMZ for a given algorithm is below 0.7, the results are not used. This represents a tradeoff between coverage, or the amount of remote sensing outputs available for use, versus the presumed accuracy of those results. This is the same tradeoff to be discussed with the new metrics, except that for the new metrics it will be applied at field scale.

### Likelihood Statistics

In some embodiments, inference results for the detection algorithms (cover crop, tillage, and irrigation) include a likelihood column. This column is meant to estimate the probability that the modeled result is correct, based on validation data and a logistic regression model. In various embodiments, reporting is provided on consistent likelihood values are across a large set of outputs (e.g., wall-to-wall inference over auto-delineated fields for several counties). An exemplary assessment of likelihood values consists of a comparison against the maximum probability returned by the underlying machine learning algorithms, e.g., the probability associated with the most likely class, and against CMZ-based F1 scores. Since the likelihood estimate is based on the actual proportion of correct values, the pattern of results appears similar to F1 score in overall magnitude, but also directionally consistent with the maximum probability, as expected.

### Anomaly Index Values

In various embodiments, inference results for all algorithms include an anomaly_index column. An anomaly index is calculated using a method called isolation forests, which models the extent of a multivariate data set in feature space. The resulting model can be used with a new set of feature inputs to determine to what extent the new inputs fall within the bounds of the training data features. There is no unequivocal way to interpret the index values, but an acceptable heuristic is to consider values greater than 0.5 to be anomalous. The likelihood results were assessed for a set of counties, one from each CMZ, and found that around 5-10% of predictions used values which could be considered outliers, i.e., anomaly index>0.5, with the proportion being around 30% for tillage. In various embodiments, a less stringent value is used when the anomaly index is used as a filter. With regard to tillage, an exemplary tillage model uses a remote sensing index (NDTI) and set of soil variables that are relatively unique to that algorithm, so it is expected that large areas of the country would show values that lie outside those used in training. When the anomaly index is to be used for screening, then different thresholds should be applied for different algorithms. In various embodiments, anomaly index may be used as a way to focus field data collection efforts on areas that do not have sufficient training data coverage.

FIG. 32 is a graph illustrating the coverage of the exemplary dataset discussed above at various thresholds, based on field level likelihood, with respect to tillage, a cover crop, and irrigation.

In exemplary embodiments, a threshold of 0.7 is applied to likelihood for the detection algorithms, and 0.5 is applied to anomaly index for all algorithms. This results in a reduction of remote sensing derived estimates, or a change in which estimates are screened out (relative to F1 score) but the resulting estimates will be much more likely to be correct. Also, this approach will expose new predictions, which have higher confidence, in areas that may have previously been precluded from inference because of a low F1 score. It will be appreciated in view of the above discussion that the alternative thresholds may be selected for individual model types.

### Case Study: Anomaly Index

During quality review of an exemplary collection of field data, a large number of disagreements were identified in a particular region. Nearly 30 percent of the fields in this area had anomaly index greater than 0.5. At the county scale, it was known that around 10% or fewer fields with anomaly index greater than 0.5 is typical. Therefore, had county scale anomaly index been monitored (e.g., the proportion of fields in a county with index>0.5), this problem could have been detected and/or remediated more quickly. Part of the monitoring plan in embodiments of the present disclosure includes that particular metric based on this case.

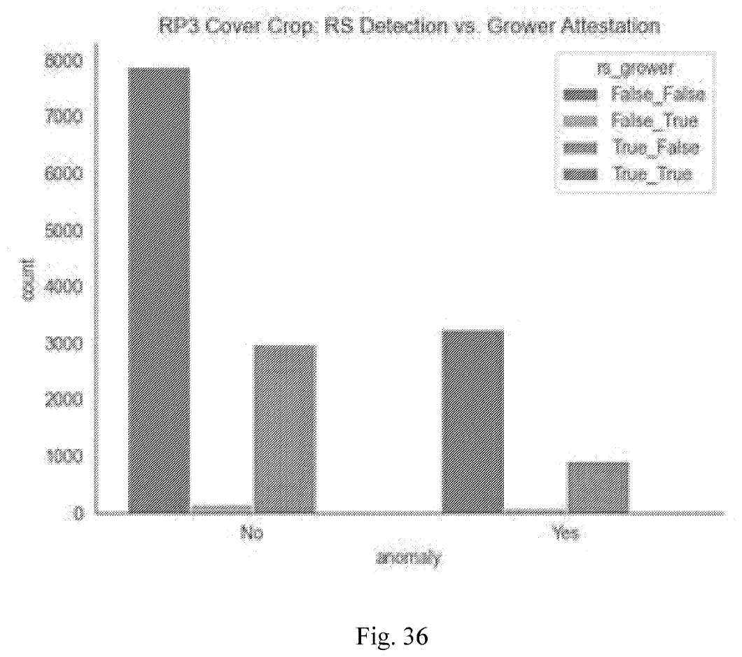

FIG. 36 is a bar graph illustrating remote sensing cover crop detection vs. grower attestation in an exemplary dataset. This graph shows the result of anomaly detection over count of cover crops, according to embodiments of the present disclosure. In some embodiments, receipt of field-level data from a user (for example, data entered by a user via a graphical user interface of a client device; geolocated data received from a field, machinery or vehicle-based sensor, etc.), automatically (e.g. without human intervention) triggers:
application of one or more machine learning models and or algorithms to data (for example, remote sensing data, USDA data, survey data, sensor data, etc.) for one or more regions comprising the received agronomic practice data,
determining an uncertainty for each of the one or more machine learning models and or algorithms,
generating an anomaly index for each of the one or more machine learning model and or algorithm, and
automatically generating a modified graphical user interface within the display of one or more client device.

In some embodiments, the modified graphical user interface is configured to accept additional input (e.g. one or more of attestation, capture of a photo or video taken from the client device, upload of one or more documents, text, numerical, geolocation, etc.) from a user if the anomaly index is greater than a threshold. In some embodiments, the modified graphical user interface comprises navigation instructions to one or more fields within the one or more regions comprising the received agronomic practice data. In some embodiments, receipt of field-level agronomic practice data from a user automatically triggers generating an anomaly index for a plurality of other fields within the one or more geographic regions. In some embodiments, the modified graphical user interface is configured to accept additional input from a user if the proportion of fields within the user request having an anomaly index greater than a threshold is greater than the proportion of other fields within the one or more geographic regions having an anomaly index greater than the threshold. In some embodiments, the threshold is 0.3, 0.4, 0.5, 0.6, 0.7, 0.8, or 0.9.

In some embodiments, receipt of field-level data from a user (for example, data entered by a user via a graphical user interface of a client device; geolocated data received from a field, machinery or vehicle-based sensor, etc.), automatically (e.g. without human intervention) triggers:
application of one or more machine learning models and or algorithms to data (for example, remote sensing data, USDA data, survey data, sensor data, etc.) for one or more regions comprising the received agronomic practice data,
determining an uncertainty for each of the one or more machine learning models and or algorithms,
generating an anomaly index for each of the one or more machine learning model and or algorithm (for example, without limitation: fields used to train each of the one or more machine learning model),
automatically sending navigation and or sample collection instructions to one or more remote devices (e.g. robot, drone, sensor, etc.).

In some embodiments, receipt of field-level data from a user (for example, data entered by a user via a graphical user interface of a client device; geolocated data received from a field, machinery or vehicle-based sensor, etc.), automatically (e.g. without human intervention) triggers:
training one or more machine learning model using data (for example, remote sensing data, USDA data, survey data, sensor data, etc.) for one or more regions comprising the received agronomic practice data, wherein the training data do not include the fields of the received field-level data,
applying the one or more trained machine learning models to the received field-level data to predict one or more of: a type of crop planted, a tillage status, a cover crop, irrigation status, planting date, harvest date, and yield,
determining an uncertainty for each of the predictions,
generating an anomaly index for each field of the training data and each field of the received field-level data, and
automatically generating a modified graphical user interface within the display of a client device.

In some embodiments, receipt of field-level data from a user automatically (e.g. without human intervention) triggers:
training one or more machine learning model using data (for example, remote sensing data, USDA data, survey data, sensor data, etc.) for one or more regions comprising the received agronomic practice data, wherein the training data do not include the fields of the received field-level data,
applying the one or more trained machine learning models to the received field-level data to predict one or more of: a type of crop planted, a tillage status, a cover crop, irrigation status, planting date, harvest date, and yield,
determining an uncertainty for each of the predictions,
generating an anomaly index for each field of the training data and each field of the received field-level data, and
automatically sending navigation and or sample collection instructions to one or more remote devices (e.g. robot, drone, sensor, etc.).

In some embodiments, training and or retraining of one or more machine learning model is automatically triggered upon a change to the available training data set (e.g. receipt of additional data (for example, receipt of data collected by one or more remote device), deletion of data, modification of data, etc.). In some embodiments, field-level data may be a field boundary. In some embodiments of any of the methods disclosed herein, the method is automatically initiated (without human intervention) upon receipt of one or more field boundaries. In some embodiments, field boundaries are automatically detected from remote sensing data (for example as described in PCT/US2020/048188, published as WO 2021/041666, which is hereby incorporated by reference).

In some embodiments, outputs of one or more machine learning model (for example, configured to predict cover crop presence, crop type, crop yield, harvest date, irrigation presence, planting date, tillage presence, etc. or combinations thereof) may be used as inputs to a model to estimate, simulate, and/or quantify the outcome (e.g., the effect on the environment) of the practices implemented on a given field. In various embodiments, the models may include process-based biogeochemical models. In various embodiments, the models may include machine learning models. In various embodiments, the models may include rule-based models. In various embodiments, the models may include a combination of models (e.g., ensemble models). Traditionally these models require significant amounts of ground truth verified input data, data that are slow and expensive to collect. In the absence of verified data, conservative and potentially not representative default values are used resulting in less accurate model outputs. Methods disclosed herein allow more efficient and accurate operation of automated systems for estimation, simulation, and/or quantification of outcome(s) (e.g., an effect on the environment, agricultural production, etc.) of the practices implemented on a field scale. For example, field-level farming practices predicted from remote sensing data may be filtered to exclude predictions with unacceptably high uncertainty values, anomalous field-level data may be automatically detected and either excluded from further analysis or augmented (e.g. with additional data collection, and optionally automatic reanalysis and or enhanced data verification requirements), predicted field-level farming practice data with high uncertainty values may be automatically may be excluded from further analysis or augmented resulting, etc. In some embodiments, field-level farming practices predicted from remote sensing data and filtered by methods of the present disclosure may be pre-populated into a data record (for example, within a farm data management system).

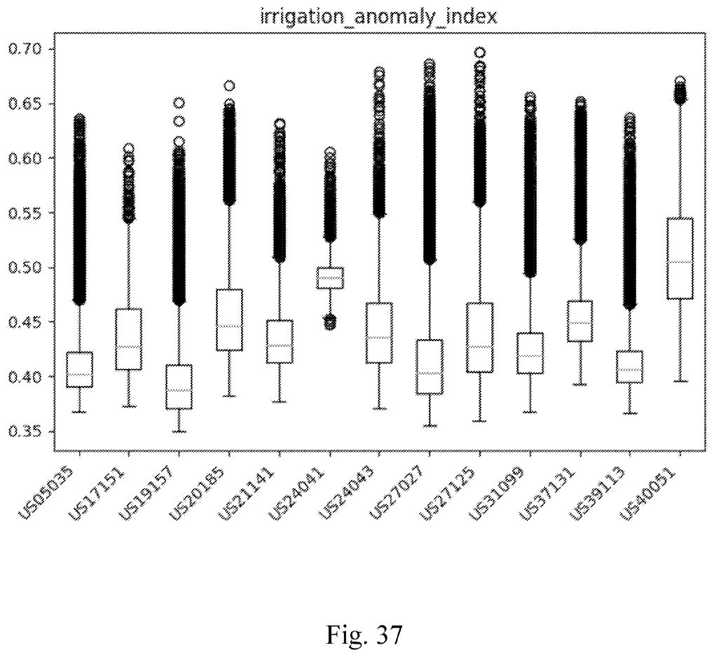

As described throughout the present disclosure, an anomaly index is calculated using a isolation forest model based on feature inputs. The anomaly index model is trained on training field features, usually one CMZ at a time. During inference, the model is applied to inference field features. FIGS. 37-41 show the distribution of anomaly index values within selected counties, one per CMZ. For each county and for each algorithm, the bar plot shows the proportion of outliers (anomaly index greater than 0.5).

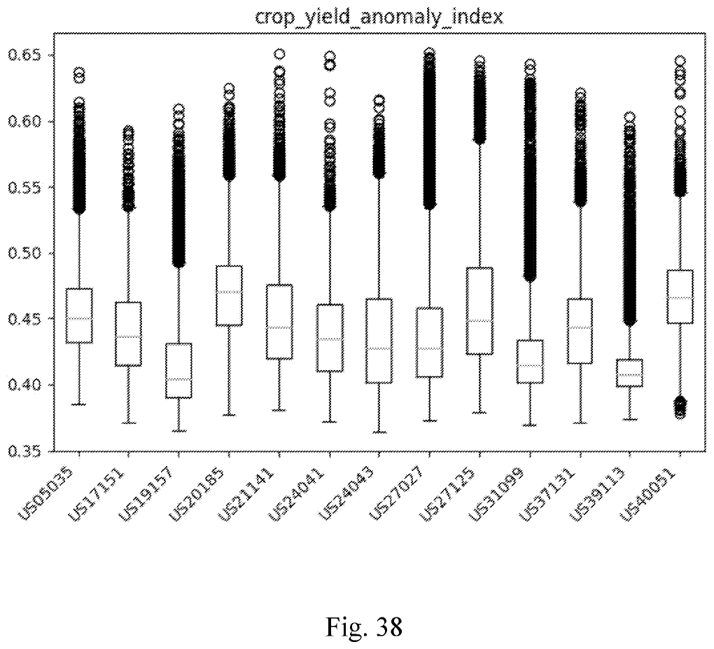

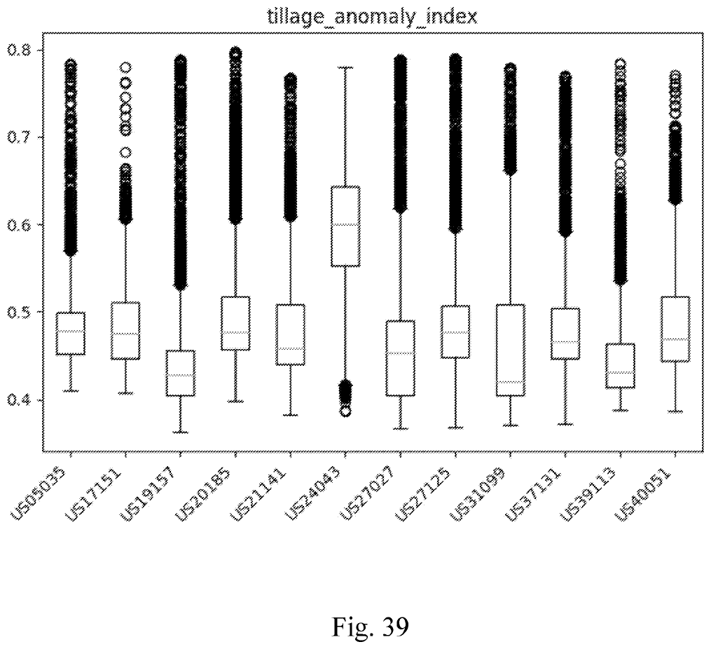

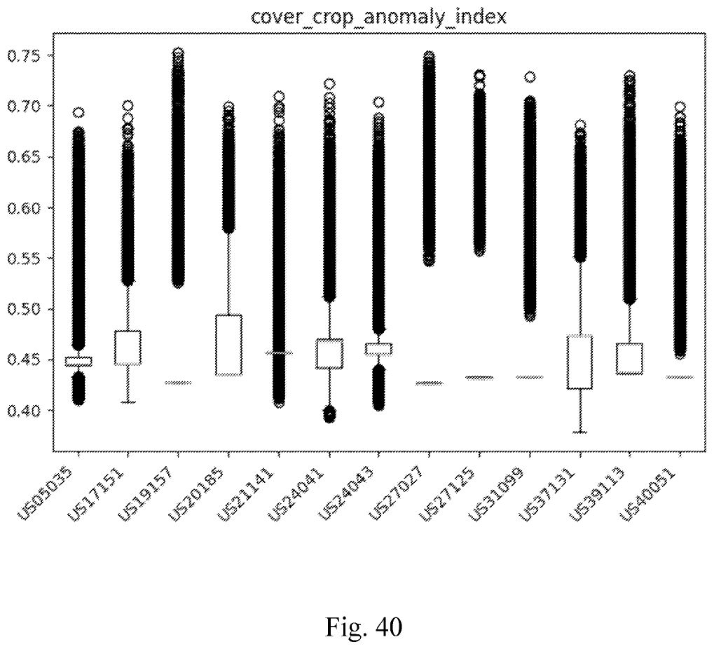

FIGS. 37-40 are graphs illustrating the anomaly index for a variety of use cases. For example, FIG. 37 illustrates an irrigation anomaly index over a number of US fields. FIG. 38 illustrates a crop yield anomaly index over a number of US fields. FIG. 39 illustrates a tillage anomaly index over a number of US fields. FIG. 40 illustrates a cover crop anomaly index over a number of US fields.

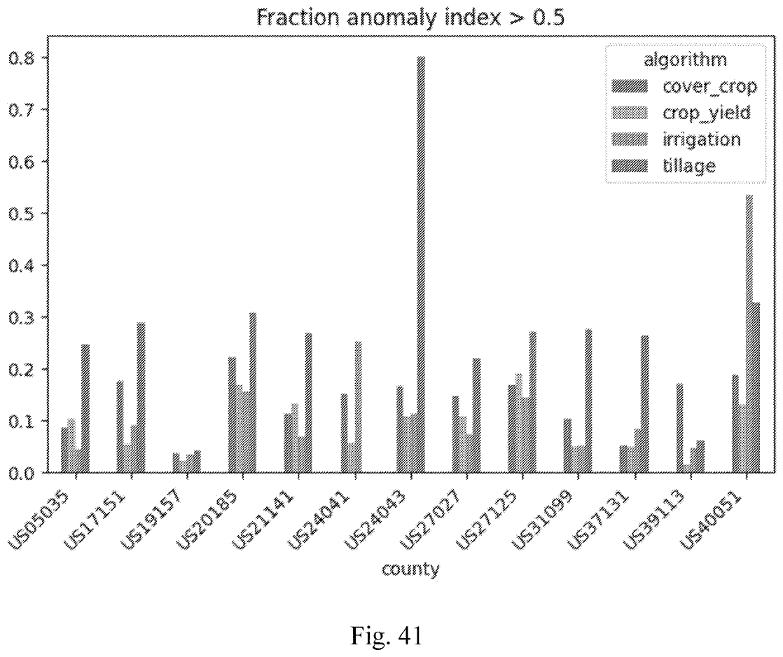

FIG. 41 is a graph illustrating the fraction anomaly index greater than 0.5 across a series of algorithms and U.S. counties.

Overall, it is expected that most values are grouped together. There are a relatively small number of outliers, usually between 5 and 20% of the fields.

Index values above 0.5 indicate that the input features for a field are unusual relative to the input features that were used to train the anomaly model (isolation tree). It is expected that most of the remote sensing, weather, etc., inputs for the fields in a county to be typical relative to the same inputs for training fields in that CMZ (though some algorithms use data outside the CMZ), thus the index values would all be bunched up, all below 0.5. However, there are some values that have unusual inputs, but not many, and those values appear as outliers on these plots.

One interesting exception is tillage for Washington County, MD (US24043). This exception shows that most of the fields predicting on have features that are atypical relative to the training data that were used to develop the model (CMZ65).

The anomaly fraction plots, showing the proportion of unusual fields in each county shows a relatively low fraction overall, as well as some variation across county and algorithm, which would be expected. The high bar for tillage in US24043 corresponds to what is seen in the box plots.

The cover crop anomaly index graph shows a cluster of values that are identical for 6 of the counties. These identical values arise when the feature values result in an isolation tree model pegged at the lowest probability value.

Likelihood is calculated using a logistic regression model using validation outputs. The likelihood model is trained on training fields, usually one CMZ at a time. During inference the model is applied to inference field outputs. This index is calculated for the classifier algorithms: tillage, cover crop, and irrigation. In this example, likelihood model inputs (inference outputs) include: prediction, max probability, aleatoric uncertainty, and epistemic uncertainty; the output is the likelihood that the model prediction was correct.

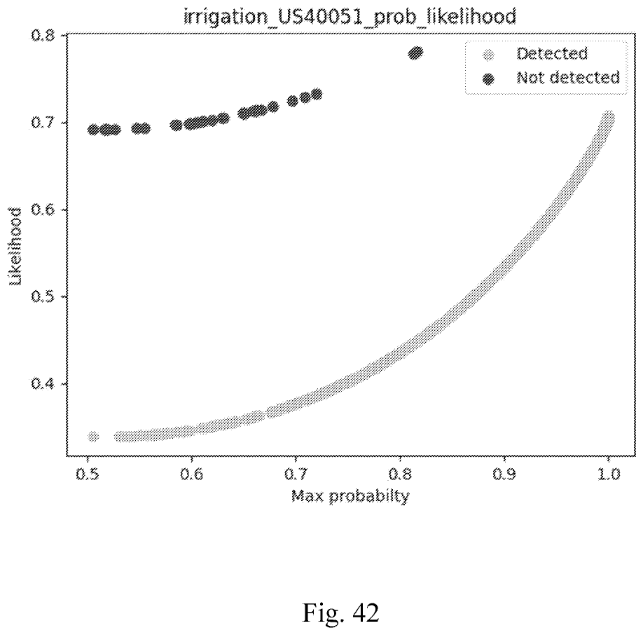

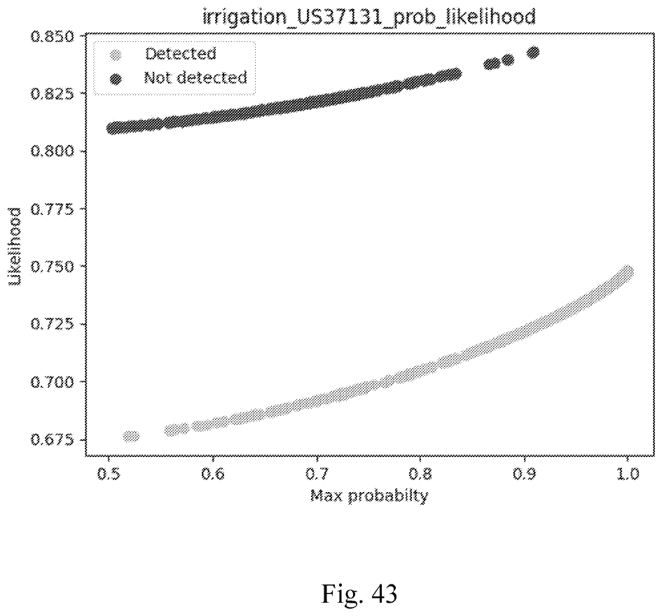

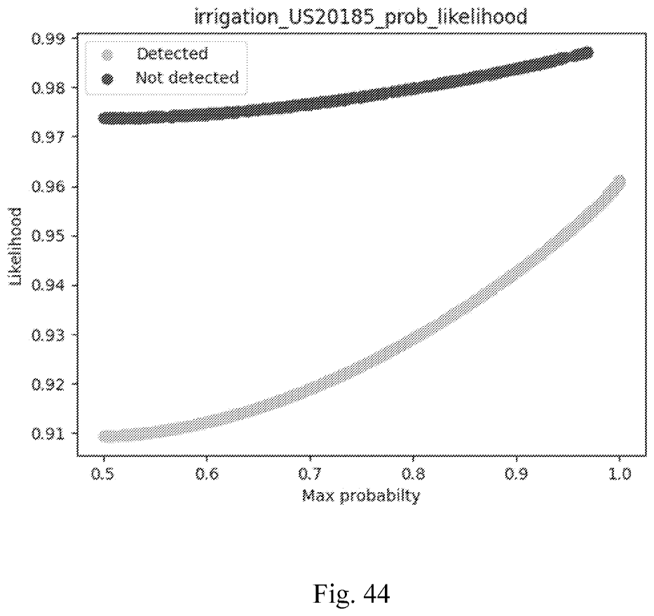

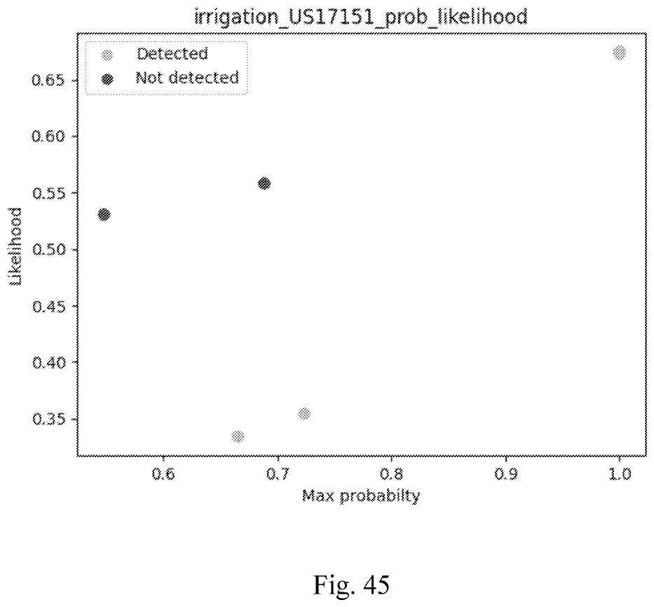

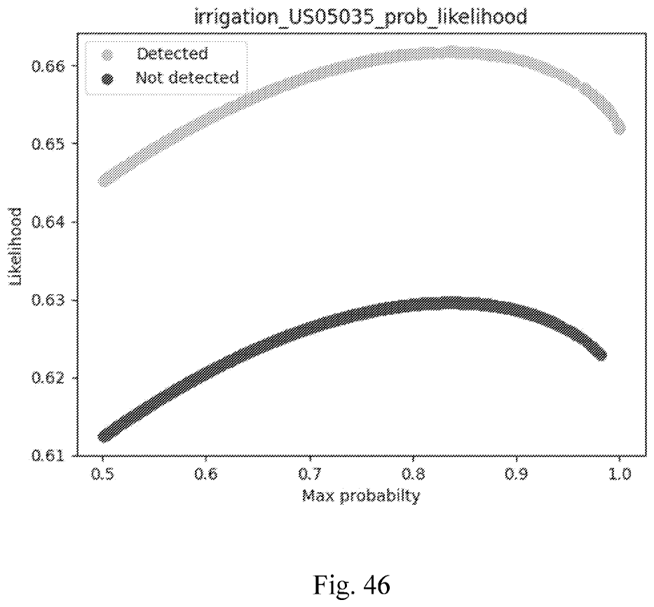

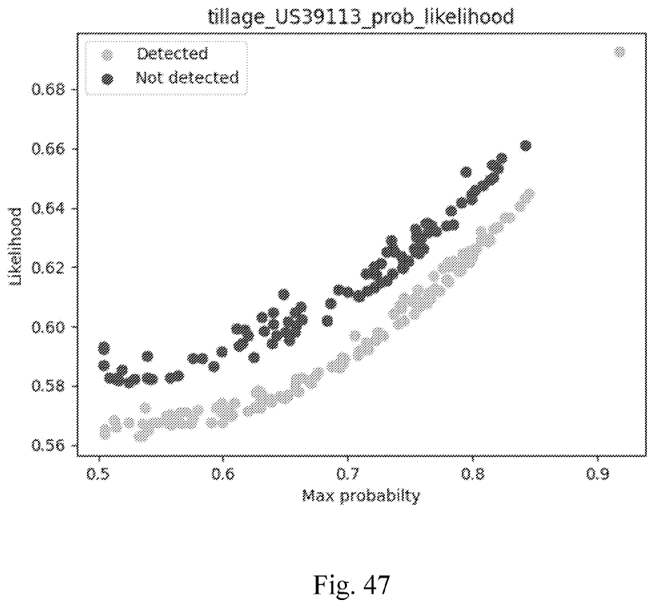

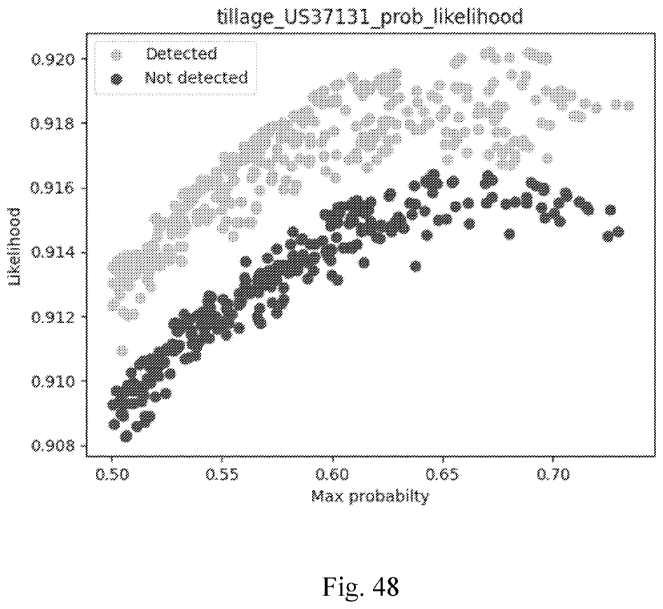

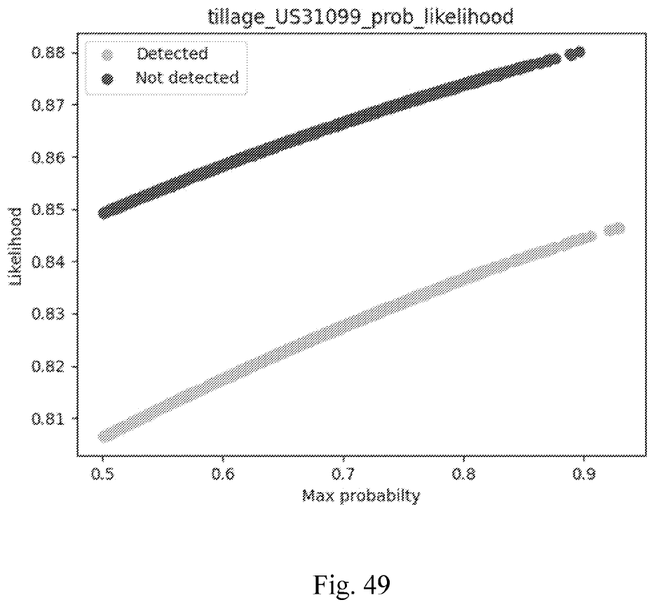

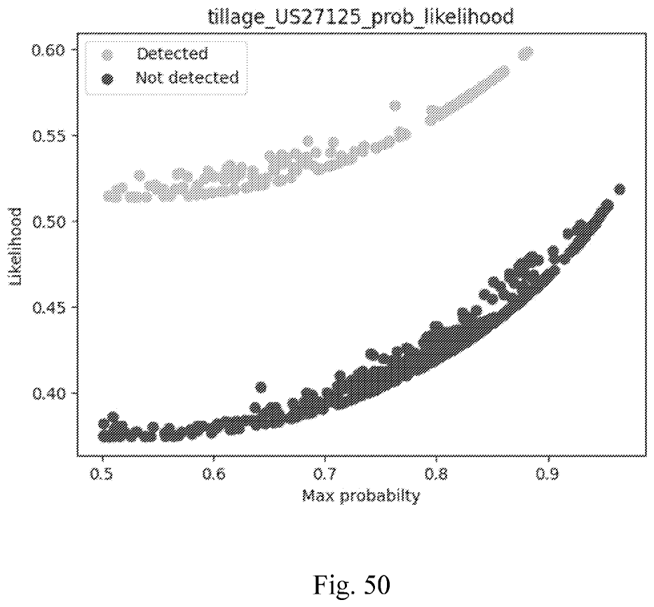

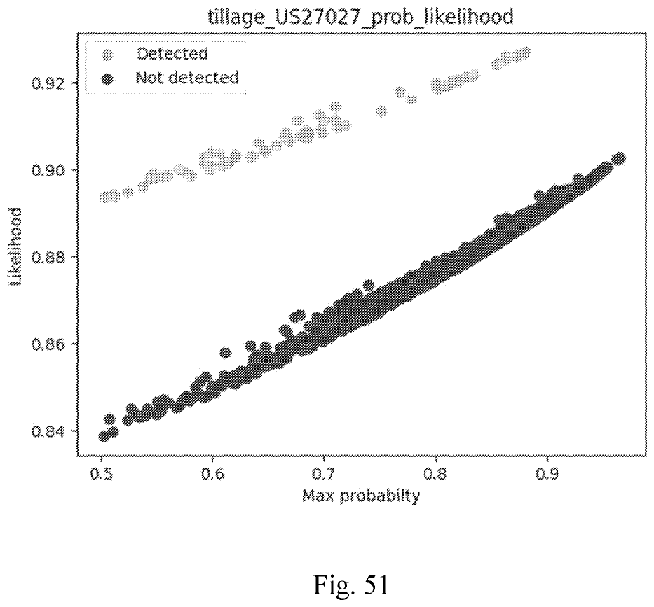

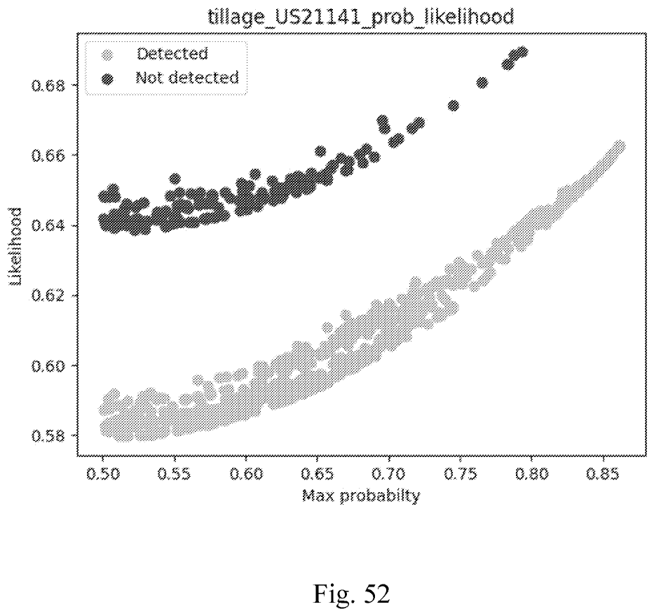

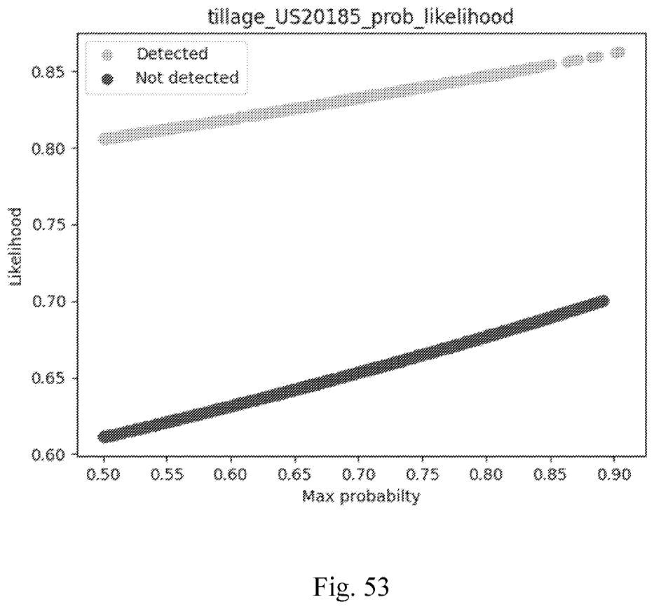

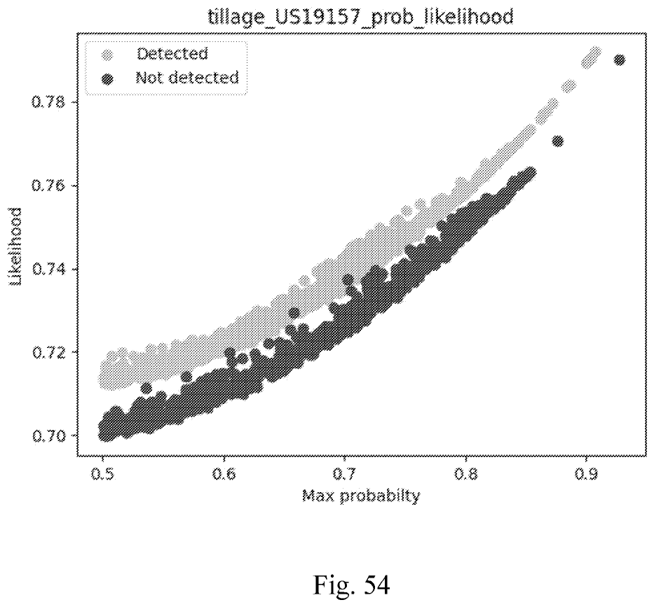

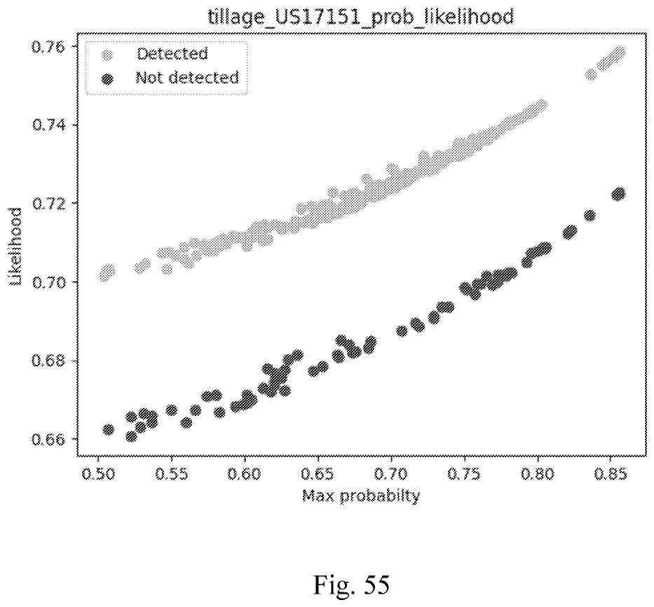

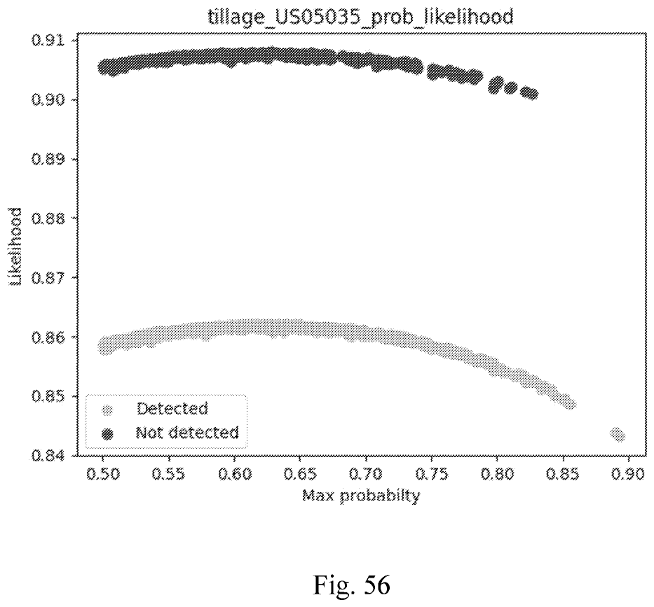

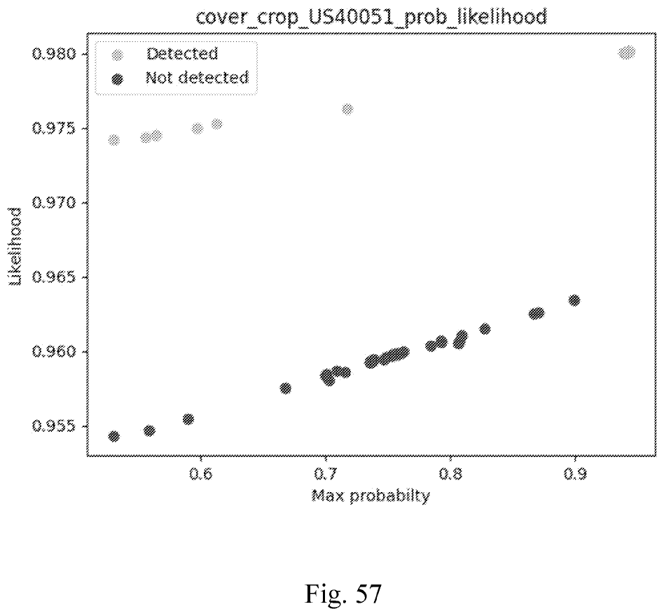

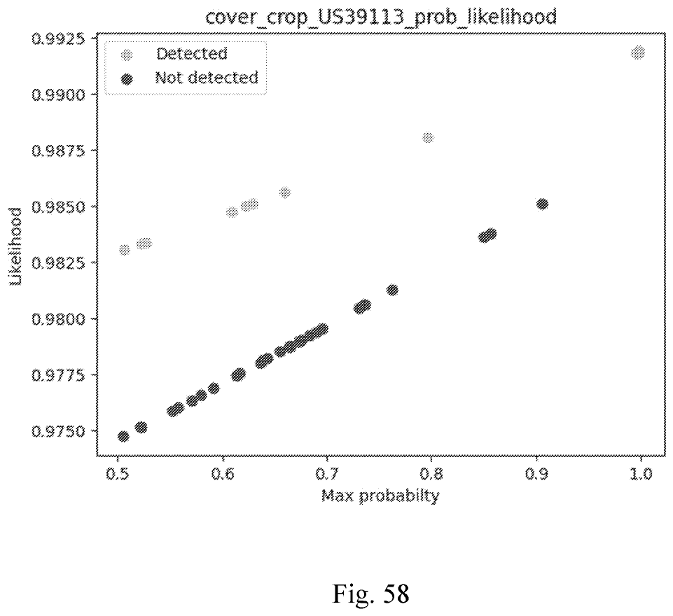

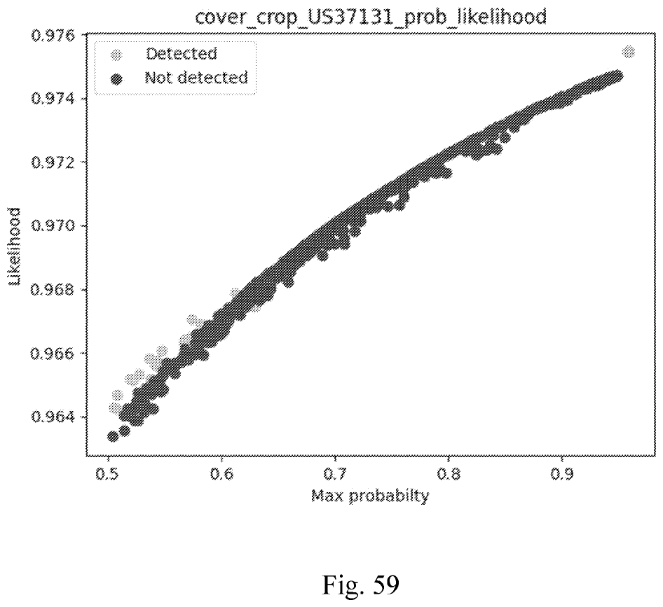

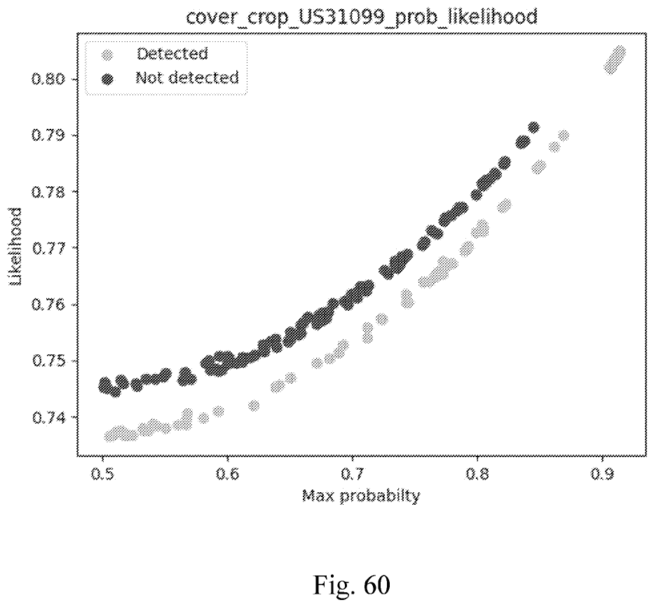

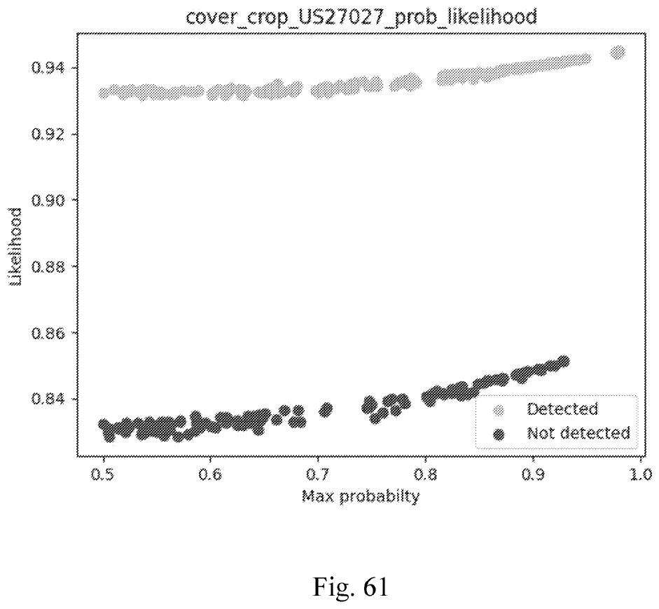

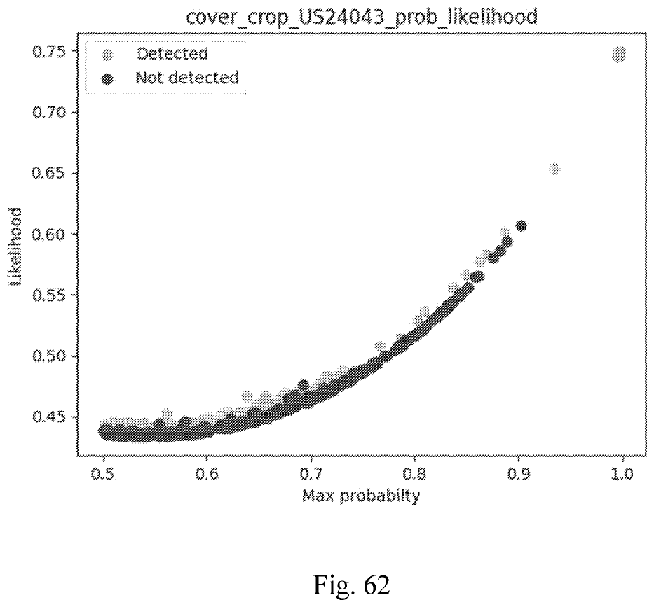

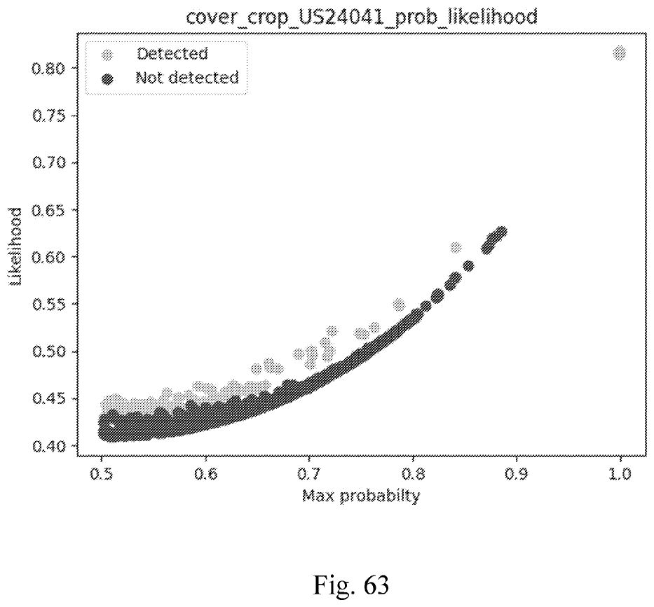

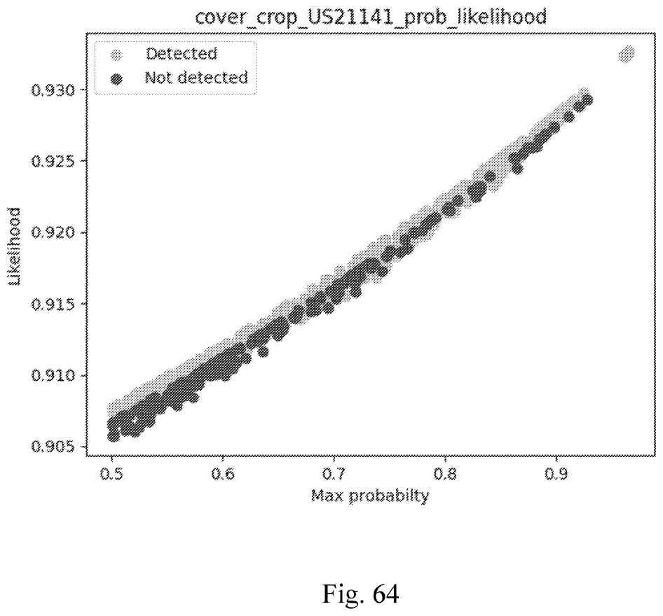

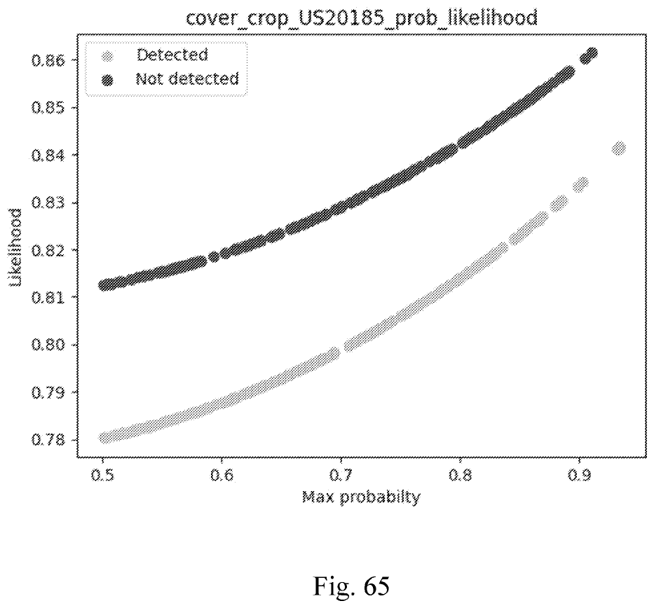

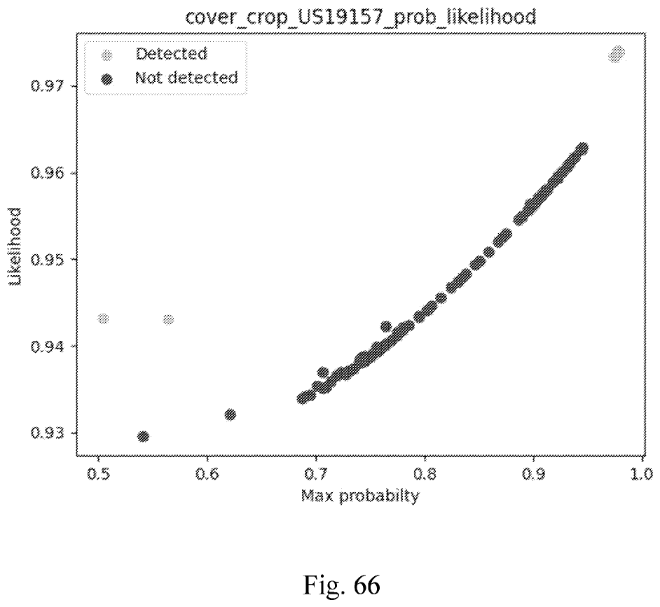

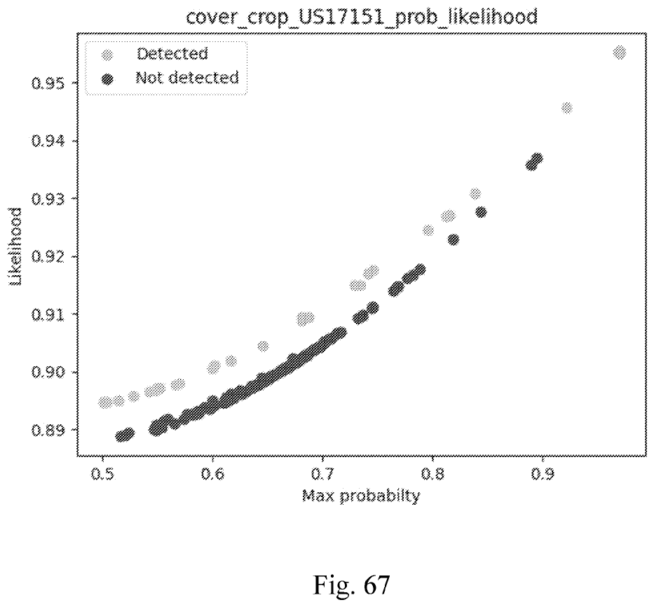

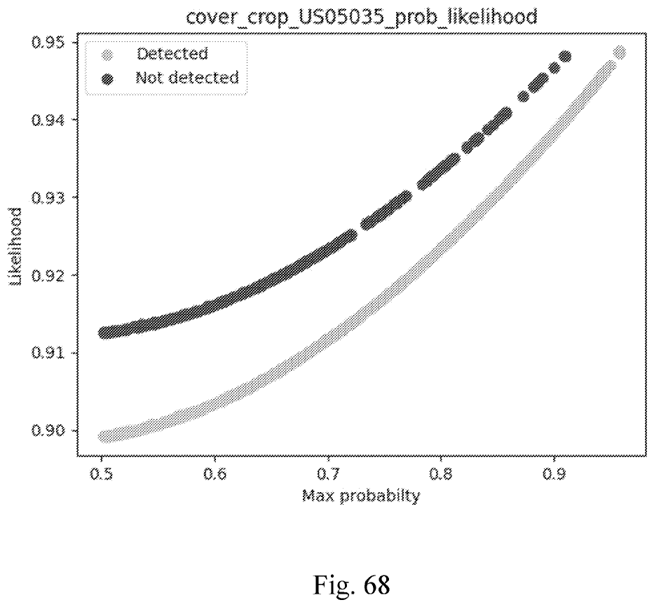

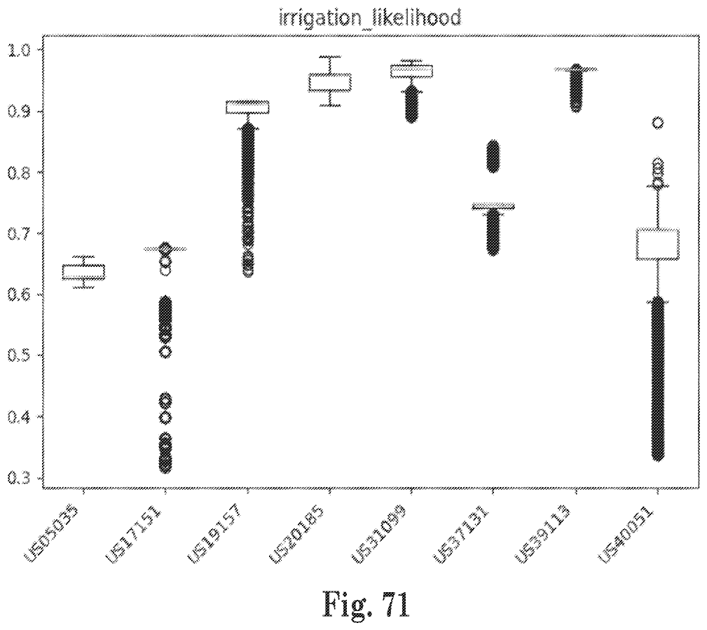

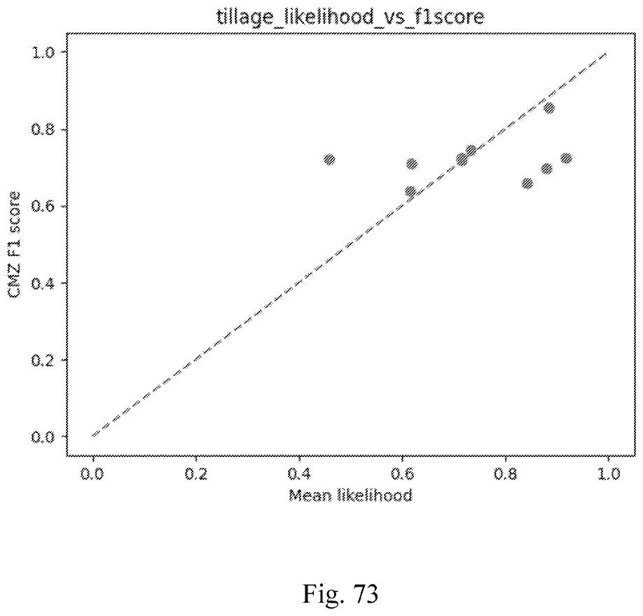

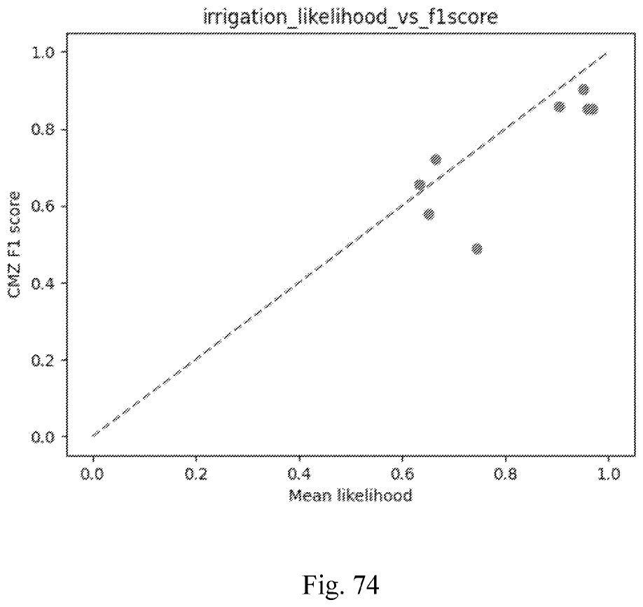

Max probability may be considered as an alternative indicator of the likelihood that the prediction is correct. FIGS. 42-74 illustrate that the two behave similarly, but are offset somewhat by whether the event was detected or not (e.g., tilled/not tilled).

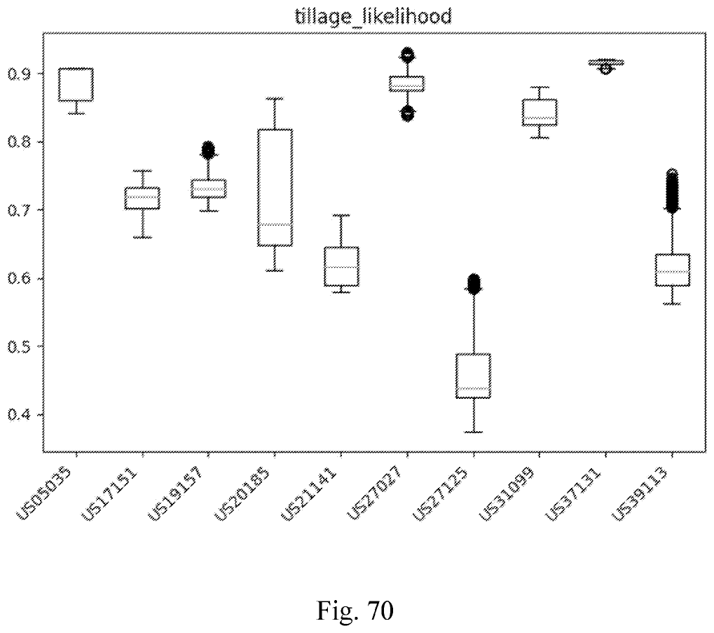

The first group of plots (FIGS. 42-69) show the distributions of likelihood across counties, one county from each CMZ, for each of the classifier algorithms. The second group of plots (FIGS. 70-74) show the likelihood of each classifier algorithm vs F1 score.

Because the likelihood model is built on top of max probability, plus other variables, it is expected for the two to be related, so this overall pattern is consistent and reasonable.

Here, max probability is the maximum of the two probabilities (for the two classes) generated by the algorithm machine learning models (though the algorithm outputs are not always strictly the same as the machine learning outputs). In many cases, likelihood values are significantly offset from max probability. The lowest max probability values are almost always near 0.5, where the model is most confused, but for a given county, in some cases all the likelihood values are greater than 0.9.

In various embodiments, likelihood is generated by a model that is fit using validation data, and is making a prediction about whether the algorithm output (e.g., 0 or 1; no-till or till) is correct, using the actual algorithm outputs and training data. So, the results for those areas are generally more accurate than the logistic probabilities would indicate. These counties are something like a random sample and are not guaranteed to be representative of the CMZs they are drawn from.

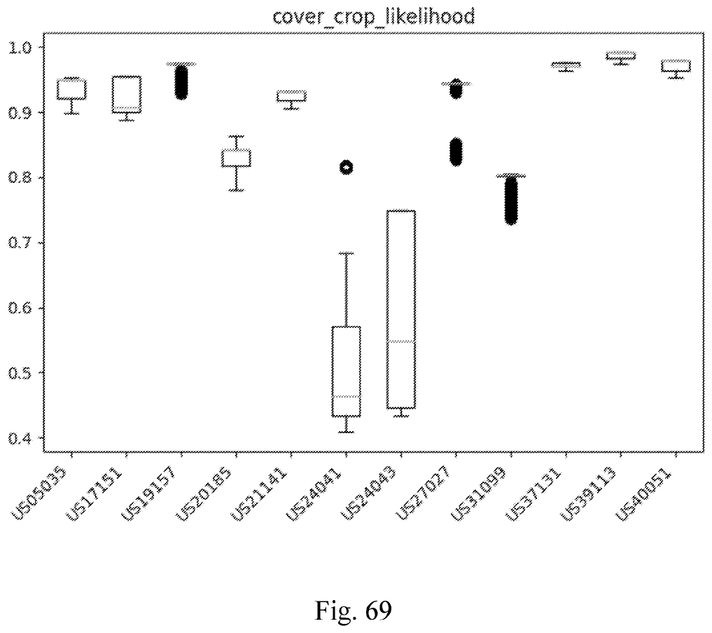

The boxplot patterns (from FIGS. 69-72) are consistent with what is seen in the previous scatter plots. In the cover crop counties with likelihoods over 0.9 for all the fields, it is known that the mean accuracies in the corresponding CMZs were high (see F1 scores). It is also known that the ML probabilities are limited and not constrained by validation accuracy, as are the likelihood values. However, since the likelihood values are derived from a model, it appears that the model may not be able to capture all the relevant variability.

However, from this analysis, that at least for training data fields, the model produces values that realistically represent the fraction of correct values for each CMZ, within bins of likelihood not across the whole CMZ or county.

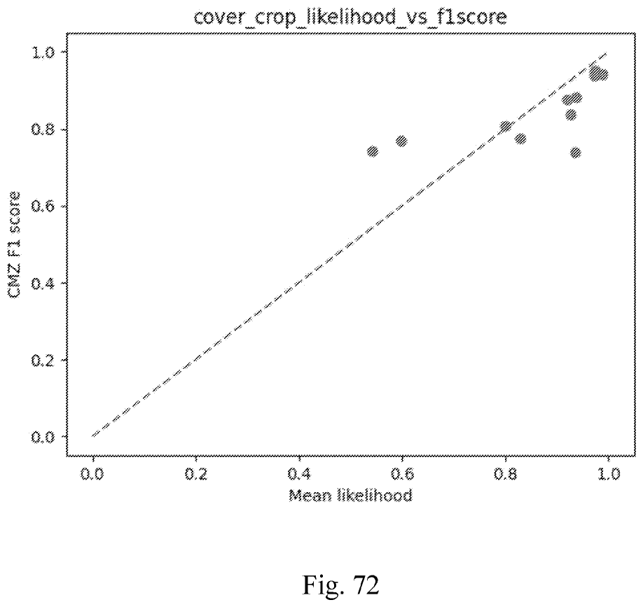

Also, as shown in the last set of plots (mean likelihood versus CMZ F1-scores as shown in FIGS. 72-74), the likelihood values for the sample counties are not inconsistent with the F1 scores of the larger body of fields within the entire CMZ. It should be noted that these counties are something like a random sample and are not guaranteed to be representative of the CMZs they are drawn from.

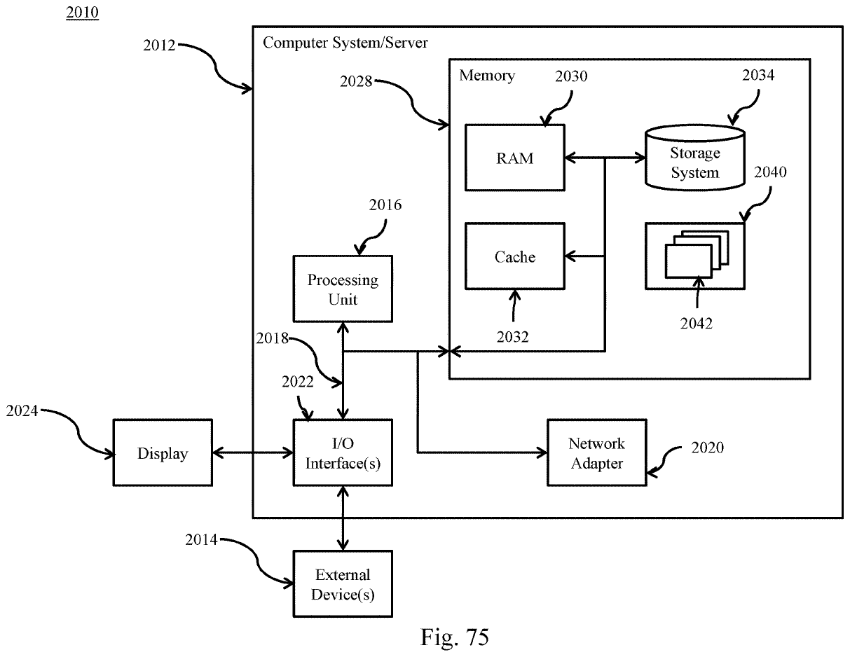

Referring now to FIG. 75, a schematic of an example of a computing node is shown. Computing node 2010 is only one example of a suitable computing node and is not intended to suggest any limitation as to the scope of use or functionality of embodiments described herein. Regardless, computing node 2010 is capable of being implemented and/or performing any of the functionality set forth hereinabove.

In computing node 2010 there is a computer system/server 2012, which is operational with numerous other general purpose or special purpose computing system environments or configurations. Examples of well-known computing systems, environments, and/or configurations that may be suitable for use with computer system/server 2012 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 2012 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 2012 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 75, computer system/server 2012 in computing node 2010 is shown in the form of a general-purpose computing device. The components of computer system/server 2012 may include, but are not limited to, one or more processors or processing units 16, a system memory 2028, and a bus 2018 that couples various system components including system memory 2028 to processor 2016.

Bus 2018 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 2012 typically includes a variety of computer system readable media. Such media may be any available media that is accessible by computer system/server 2012, and it includes both volatile and non-volatile media, removable and non-removable media.

System memory 2028 can include computer system readable media in the form of volatile memory, such as random access memory (RAM) 2030 and/or cache memory 2032. Computer system/server 2012 may further include other removable/non-removable, volatile/non-volatile computer system storage media. By way of example only, storage system 2034 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 2018 by one or more data media interfaces. As will be further depicted and described below, memory 2028 may include at least one program product having a set (e.g., at least one) of program modules that are configured to carry out the functions of embodiments of the disclosure.

Program/utility 2040, having a set (at least one) of program modules 2042, may be stored in memory 2028 by way of example, and not limitation, as well as an operating system, one or more application programs, other program modules, and program data. Each of the operating system, one or more application programs, other program modules, and program data or some combination thereof, may include an implementation of a networking environment. Program modules 2042 generally carry out the functions and/or methodologies of embodiments as described herein.

Computer system/server 2012 may also communicate with one or more external devices 2014 such as a keyboard, a pointing device, a display 2024, etc.; one or more devices that enable a user to interact with computer system/server 2012; and/or any devices (e.g., network card, modem, etc.) that enable computer system/server 2012 to communicate with one or more other computing devices. Such communication can occur via Input/Output (I/O) interfaces 2022. Still yet, computer system/server 2012 can communicate with one or more networks such as a local area network (LAN), a general wide area network (WAN), and/or a public network (e.g., the Internet) via network adapter 2020. As depicted, network adapter 2020 communicates with the other components of computer system/server 2012 via bus 2018. It should be understood that although not shown, other hardware and/or software components could be used in conjunction with computer system/server 2012. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of determining an uncertainty of a machine learning model, the method comprising:
initializing a plurality of models, each with a unique set of model parameters;
reading a training dataset;
selecting a unique subset of the training dataset for each of the plurality of models;
training each of the plurality of models according to its unique set of model parameters and unique subset of the training data;
reading a validation dataset;
applying each of the plurality of models to the validation dataset to obtain a plurality of output distributions; and
determining an uncertainty from the plurality of output distributions.

2. The method of claim 1, wherein the unique set of model parameters for each of the plurality of models includes at least one randomized model parameter.

3. The method of claim 1, wherein each unique subset is selected from the training dataset randomly.

4. The method of claim 1, wherein each of the plurality of models is a random forest.

5. The method of claim 1, wherein determining the uncertainty comprises:
computing Shannon's entropy; and
quantifying the probability of an estimate falling within a credible interval.

6. (canceled)

7. The method of claim 1, further comprising:
assigning a weight to each of the plurality of models to produce a weighted ensemble model; and
applying the weighted ensemble model to an input to determine a classification and an uncertainty.

8. (canceled)

9. The method of claim 1, wherein the training dataset comprises remote sensing data.

10. The method of claim 1, wherein the validation dataset comprises remote sensing data.

11. The method of claim 1, further comprising:
receiving field-level data from a user, comprising data for a plurality of fields as input data for the plurality of models; and
automatically determining uncertainty for the field-level data using the output plurality of distributions from the plurality of models.

12. The method of claim 11, further comprising generating an anomaly index for each of the plurality of fields.

13. The method of claim 12, wherein generating the anomaly index comprises applying an isolation forest or applying a predetermined threshold to the anomaly index for each of the plurality of field.

14. (canceled)

15. The method of claim 12, further comprising:
prompting user for additional input for those of the plurality of fields having an anomaly index exceeding the predetermined threshold; and
generating or modifying a graphical user interface (GUI) of a client device according to the anomaly index and the additional input;
wherein the graphical user interface comprises navigation and or sample collection instructions.

16-17. (canceled)

18. A method of determining an uncertainty of a prediction, the method comprising:
determining a time-series derived metric for each of a plurality of subregions of a first region;
determining a rank percentile score of the time-series derived metric for each of the plurality of subregions;
determining a threshold of the time-series derived metric indicative of an agricultural event based on an adoption rate;
based on the threshold, reclassifying each of the plurality of subregions;
base on the reclassification, estimating a logistic regression while generating posterior distributions of a plurality of regression parameters;
based on a mean and a variance of the posterior distributions, determining a probability of the agricultural event for a first subregion of the first region;
determining an uncertainty the first subregion based on a mean value of the posterior distribution of each parameter of the logistic regression.

19. The method of claim 18, wherein:
each of the plurality of subregions is a field,
the first region is a county, and
the agricultural event is a transition between tilling practices, transition between cover crop practices, or transition in irrigation practices.

20-21. (canceled)

22. A method of determining an uncertainty of a prediction, the method comprising:
for a first geographic region, determining a historical value of a first parameter;
for a second geographic region, determining a predicted value of the first parameter, the second geographical region being a subregion of the first geographical region;
determining a posterior probability of the predicted value based on the historical value;
determining an uncertainty of the predicted value based on the posterior probability.

23. The method of claim 22, wherein the first geographic region is a county and the second geographic region is a field.

24. The method of claim 23, wherein the historical value is determined from agricultural census data.

25. The method of claim 23, wherein the predicted value is determined from a machine learning model.

26. The method of claim 23, wherein the first parameter is selected from cover crop presence, crop type, crop yield, harvest date, irrigation presence, planting date, tillage presence.

27-28. (canceled)
